(19) United States
(12) Patent Application Publication
(10) Pub. No.: US 2025/0334982 A1
(43) Pub. Date: Oct. 30, 2025

(54) COMPUTING DEVICE, PRESSURE CONTROL STATION, SYSTEM AND METHODS FOR CONTROLLING FLUID PRESSURE IN A FLUID DISTRIBUTION NETWORK CONTROLLING FLUID PRESSURE IN A FLUID DISTRIBUTION NETWORK

(71) Applicant: Utonomy Ltd, Southampton (GB)

(72) Inventor: Samuel Taylor, Southampton (GB)

(21) Appl. No.: 18/864,537

(22) PCT Filed: May 11, 2023
(86) PCT No.: PCT/GB2023/051237

§ 371 Date: Nov. 10, 2024

(30) Foreign Application Priority Data
May 12, 2022 (GB) 2206933.0

(51) Int. Cl. G05D 16/20

(52) U.S. Cl. CPC G05D 16/20

(57) ABSTRACT

A method performed by a computing device for controlling fluid pressure in a fluid distribution network (FDN) above a threshold pressure by communicating with a plurality of pressure control stations distributed throughout the FDN to independently control a fluid pressure at each of the plurality of pressure control stations is provided. The method comprises training a machine learning algorithm to establish one or more correspondences between a measured variation in fluid demand in the FDN for a first time period and measured environmental conditions for the first time period. The method comprises predicting a variation in fluid demand in the FDN for a second, later time period based on predicted environmental conditions for the second time period and the established one or more correspondences between the measured variation in fluid demand in the FDN for the first time period and the measured environmental conditions for the FDN for the first time period. The method comprises determining, based on the predicted variation in fluid demand for the second time period, a variation in fluid pressure to be applied at the plurality of pressure control stations for the second time period to satisfy a fluid pressure condition at one or more pre-determined points in the FDN downstream from the plurality of pressure control stations. The method comprises transmitting, to the plurality of pressure control stations, an indication of the determined variation in fluid pressure to be applied at the plurality of pressure-control stations for the second time period to satisfy the fluid pressure condition at the one or more pre-determined points in the FDN.

### BACKGROUND

The present technique relates to a computing device, pressure-control station, system and methods for controlling fluid pressure in a fluid distribution network.

The present application claims the Paris Convention priority of UK patent application number 2206933.0, the contents of which are hereby incorporated by reference in their entirety.

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Fluids such as liquids or gases are sometimes distributed by a network of pipes which convey the fluid under pressure from a source to one or more consumer points. One example of such networks are gas distribution networks such as that used to provide consumers with combustible gas for consumption by both industrial and domestic consumers.

Gas distribution networks (GDNs) distribute gas from a gas source to consumers of the gas such as domestic residence, commercial or industrial premises. GDNs are typically formed from a network of pipelines through which the gas passes under pressure from a source to reach the consumers. The gas pressure in the network is set by one or more pressure control stations known as district governor stations (alternatively referred to as “governor stations”) which receive the gas from a source. It is generally desirable to set the pressure in the network to achieve a balance between: safety, maintaining consumer service levels and gas leakage in the GDN. A gas supply pressure which is too low may be dangerous to consumers. For example, a low gas supply pressure may lead to incomplete combustion and consequent formation of carbon monoxide, a poisonous gas, or consumer devices simply not functioning. There is therefore a statutory requirement that the gas supply pressure in GDNs should not fall below a minimum value. Conversely, GDNs may be prone to leakage which is of both environmental and financial concern to gas suppliers. Generally leakage increases with the gas supply pressure. A gas supplier may therefore wish to impose a maximum gas supply pressure in the GDN to reduce the financial loss and environmental impact of gas leakage. It is therefore desirable to control the gas supply pressure in GDNs to be high enough to comply with the statutory minimum requirement yet low enough to reduce financial loss and environmental impact due to gas leakage.

A pressure of a gas supply at a point in a GDN is determined by a plurality of factors including: a pressure at one or more governor stations supplying the point in the GDN, the distance the point is away from the one or more governor stations and a demand for the gas supply. Typically, a pressure of the gas is measured at one or more pressure low points in the GDN using digital gas pressure data loggers which may be alternatively referred to as “low-point loggers”. A low-point is a point in the GDN which has a low (possibly minimum) pressure. The GDN may have a number of low-points.

A higher demand for gas results in a decrease in the pressure at the low-points in the GDN as consumers of the gas supply consume gas. An increased gas supply demand decreases the gas supply pressure in the GDN and vice versa. Consequently, gas suppliers are required to supply gas at a high enough pressure which takes into consideration potential pressure drops due to increased demand.

In some GDNs, gas supply pressures are set manually at governor stations. The gas supply pressure is typically set at a high value to prepare for a worst case scenario. For example, the pressure may be set at a pressure high enough such that the pressure at the low-points is expected to remain above the statutory minimum requirement even if the gas demand is expected to be the highest gas demand of any day. In some GDNs, governor stations are configured to automatically change a gas supply pressure based on a “clock”. For example, the governor stations may supply gas at one pressure during the day and at another pressure during the night. In some GDNs, governor stations are configured to alter a gas supply pressure based on pre-determined pressure profiles.

For some GDNs, such as those which supply bio-methane gas, there is a desire to prevent GDN pressure from exceeding a pre-determined threshold. For example, it becomes difficult to feed bio-methane gas into a GDN if the pressure in the GDN exceeds a pre-determined threshold. Similarly, it becomes difficult to feed the bio-methane gas into the GDN if a pressure ratio between the GDN pressure and a bio-methane planet outlet pressure exceeds a pre-determined threshold. Current approaches solve this problem by burning excess bio-methane gas by flaring.

The above-described technical challenges faced in controlling gas pressure in GDNs are representative examples of the difficulties encountered in accurately controlling fluid pressure in fluid distribution networks, FDN, more generally. There is therefore a desire to control fluid pressures at pressure control stations in fluid distribution networks more accurately in response to changing environmental conditions.

### SUMMARY OF DISCLOSURE

Embodiments can provide a method performed by a computing device for communicating with one or more pressure-control stations to control fluid pressure in a fluid distribution network, FDN. The method comprises training a machine learning algorithm to establish one or more correspondences between a measured variation in fluid demand in the FDN for a first time period and measured environmental conditions for the first time period. The method comprises predicting a variation in fluid demand in the FDN for a second, later time period based on predicted environmental conditions for the second time period and the established one or more correspondences between the measured variation in fluid demand in the FDN for the first time period and the measured environmental conditions for the FDN for the first time period. The method comprises determining, based on the predicted variation in fluid demand for the second time period, a variation in fluid pressure to be applied at the one or more pressure control stations for the second time period to satisfy a fluid pressure condition at one or more pre-determined points in the FDN downstream from the one or more pressure control stations. The method comprises transmitting, to the one or more pressure control stations, an indication of the determined variation in fluid pressure to be applied at the one or more pressure-control stations for the second time period to satisfy the fluid pressure condition at the one or more predetermined points in the FDN.

According to example embodiments, by predicting a variation in fluid demand for a time period for predicted environmental conditions (e.g. from a weather forecast), a corresponding predicted variation in fluid pressure to be applied at a pressure-control station can be made (for example, by varying pressure control station settings) in order to match demand for forecast environmental conditions. An indication of the variation in fluid pressure to be applied at the pressure-control station (for example, the pressure control station settings) is transmitted to the pressure control station. The indication can be transmitted in advance of a later time period to control the fluid pressure in the fluid distribution network for that time period. Therefore a fluid pressure condition at one or more predetermined points in the FDN downstream from the pressure control station can be satisfied by taking account of demand.

In some embodiments, the fluid pressure condition at the one or more pre-determined points in the FDN downstream from the pressure control stations is a condition to minimise excess pressure in the FDN. For example, the excess pressure may be a difference between a fluid pressure at a pressure low point located at an extremity of the FDN and a minimum permitted fluid pressure. The minimum fluid pressure may be a statutory minimum fluid pressure. In some embodiments, the fluid pressure condition at the one or more pre-determined points in the FDN downstream from the pressure control stations is a condition to minimise a difference between a fluid pressure at the one or more pre-determined points in the FDN and a maximum permitted fluid pressure. In some embodiments, the fluid pressure condition at the one or more pre-determined points in the FDN downstream from the pressure control stations is a condition that the fluid pressure at the one or more pre-determined points falls within a predefined maximum and minimum fluid pressure.

The one or more pre-determined points downstream from the one or more pressure control stations may be any point along the FDN which receives fluid from the one or more pressure control stations. For example, the one or more pre-determined points may be pressure low points at extremities of the FDN.

In exemplary embodiments, the FDN is a GDN and the one or more pressure-control stations are governor stations.

In exemplary embodiments the computing device is for controlling fluid pressure in an FDN above a threshold pressure by communicating with a plurality of pressure-control stations distributed throughout the FDN to independently control a fluid pressure at each of the plurality of pressure control stations. Such embodiments provide increased flexibility in the control of fluid pressure in the FDN.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 illustrates a simplified Gas Distribution Network (GDN);

FIG. 2 is a schematic diagram illustrating a section of a GDN which serves a plurality of consumers with gas along a route;

FIG. 3 is a graph of gas pressure against time for a 24 hour period for the section of a GDN for a constant governor pressure;

FIG. 4 is a graphical illustration of a method for controlling a gas according to exemplary embodiments;

FIG. 5A is a graphical plot of average low-point pressure against time for a cold and warm winter day;

FIG. 5B is a graphical plot of a daily average low-point pressure against overnight temperature;

FIG. 6 is an example of a gas demand proxy measured over a week with corresponding air and overnight temperatures governor average pressure and low-point pressure over twenty four hour periods;

FIG. 7 is a flow diagram illustrating training of a machine learning algorithm to predict a gas demand proxy according to exemplary embodiments;

FIG. 8 is a graph of a parameterised gas demand proxy against time according to exemplary embodiments;

FIG. 9 is a flow diagram illustrating how a low-point pressure can be used to obtain an estimation of optimal governor pressures according to exemplary embodiments.

FIG. 10 shows results of a simulation of a low-point pressure model according to exemplary embodiments;

FIG. 11 is a graph of pressure against time for a variable governor pressure.

FIG. 12 illustrates a comparison between using a constant governor pressure and a variable governor pressure in a GDN according to exemplary embodiments;

FIG. 13 is a schematic diagram illustrating an actuator for adjusting a pilot valve providing a remote means of adjusting gas pressure at governor stations in accordance with exemplary embodiments;

FIG. 14 illustrates an overview of a fluid control system according to exemplary embodiments;

FIG. 15 is a flow diagram illustrating a method performed by a computing device in accordance with example embodiments.

### DESCRIPTION OF EXAMPLE EMBODIMENTS

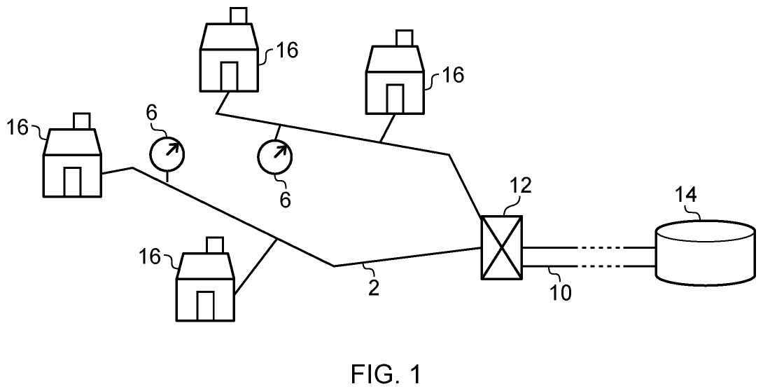

As mentioned above, embodiments of the present technique can improve an accuracy with which pressure in a fluid distribution network is controlled with respect to a demand for that fluid. A better understanding of example embodiments can be appreciated for an example of gas distribution network such as an area combustible gas distribution network. A consumer of gas may be an industrial, commercial or domestic consumer or the like, which receives a gas supply from a Gas Distribution Network (GDN). The term “gas distribution network” is used herein to refer to a network of pipes and one or more governor stations for distributing gas to one or more consumers. It will be appreciated that a GDN is an example of a Fluid Distribution Network (FDN). An example of a GDN is illustrated in FIG. 1. FIG. 1 is a simplified representation of a GDN 2 in which a gas source 14 supplies gas through a distribution pipe 10 to a governor station 12. The governor station 12 controls a pressure of gas from the gas distribution pipe 10 to the gas distribution network 2 at a lower pressure than the pressure in the gas distribution pipe 10. The GDN 2 supplies a plurality of consumers 16 with the gas from the source 14 via the governor station 12. A plurality of low point loggers 6 are used to measure a gas pressure at low points in the GDN 2.

The gas source 14 is a generally representation of a source of gas which may be a standalone container of gas or one or more other gas networks. For example, the National Grid System is a network serving high pressure gas which is delivered to GDNs throughout the UK. The gas source may also be a source of bio gas (such as bio-methane) generated from a source such as a farm or dedicated plant. It will be appreciated that although a single gas source 14 is shown in FIG. 1, a GDN 2 may have a plurality of gas sources.

Gas pressure is typically highest at a source into the GDN and lowest at extremities of the GDN as a result of gas leakage and gas usage by consumers. For example, the national grid may supply high pressure gas at one of the sources of a GDN. Gas moves through the pipes driven by the pressure and, with gas usage by consumers and leakage causing the pressure to drop. A governor station (or governor) in a GDN typically receives the gas from the higher pressure gas source and contains pressure control means to lower the pressure of the gas received from the gas source. Consequently, the pressure of gas arriving at a governor is higher than the pressure of gas leaving the governor. In one example, gas arrives at a governor station with a pressure of about 1 to 2 bar and leaves the governor station with a pressure of up to about 50 mbar. A gas pressure received by the one or more consumers will typically be lower than the pressure leaving the governor due to consumer usage of gas and due to gas leakage. Hence, one or more points exist in a GDN for which a gas pressure may be low or minimal. Low-point loggers 6 are typically placed at some or all of these locations to monitor the gas pressure there as shown in FIG. 1. For example, the low-points may be located using models calibrated by measurements of pressure throughout the GDN, and the low-points loggers 6 are placed at the low-points.

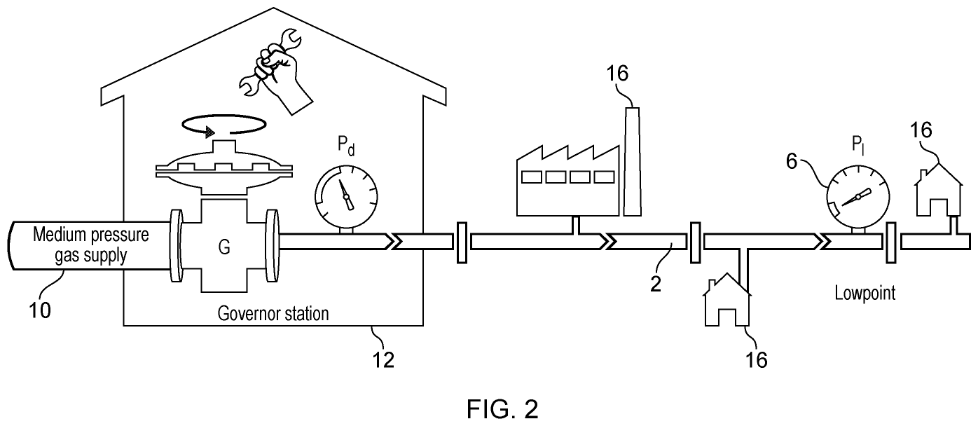

FIG. 2 is a schematic diagram illustrating a section of the GDN 2 shown in FIG. 1 which serves a plurality of consumers with gas. As shown in FIG. 2 the governor station 12 receives medium pressure gas through the gas distribution supply pipe 10. As mentioned above, the source of the medium pressure gas supply is not limited and may be, for example, a connection to another GDN. The governor station 12 alters the medium pressure gas supply to a pressure P_{d}. The governor station 12 may alter the gas pressure through the use of pressure control means such as a pilot valve and an actuator. The gas at pressure P_{d} leaves the governor station and enters a network of pipes of the GDN 2 to supply the gas to the plurality of consumers 16. The low-point logger 6 is typically disposed at a point near the edge of the GDN 2 which is likely to have a low or minimal gas pressure. In FIG. 2, a pressure P₁ is measured at the low point 6. The governor 12 is configured manually with settings to reach the pressure P_{d}.

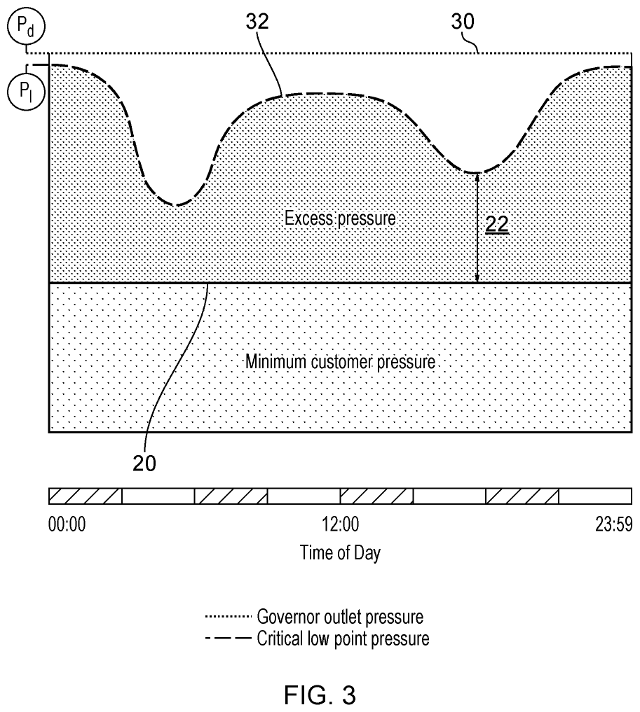

The gas pressure P_{d} is conventionally set manually. As will be appreciated, gas consumption typically varies throughout the year commensurate with environmental conditions. For example during winter in northern Europe, the weather is typically colder and so gas consumption will increase. Accordingly, the gas pressure P_{d} at the governor station 12 is set manually with different pressures between summer and winter. The pressure P_{d} set by the governor station 12 is required to ensure that the gas pressure P₁ at the low point 6 is above a minimum required by consumers 16 to operate gas burning devices. However the pressure in the GDN 2 will vary as a function of demand for gas from the consumers 16 connected to the GDN 2. This necessitates setting the pressure P_{d} at the governor station 12 to a value which delivers the minimum pressure at the low point 6 when consumer demand is highest. As a result, when a demand for gas is lower, the pressure set by the governor station 12 is higher than it needs to be, which can increase an amount of gas leakage from the GDN 2. FIG. 3 provides an example illustration of a need to set the gas pressure at the governor station 12 to a maximum when the demand is greatest which can result in too much pressure in the GDN 2 at other times.

FIG. 3 provides an illustration of a graphical plot of gas pressure against time for a 24 hour period for the GDN 2 of FIG. 2. FIG. 3 provides a graphical plot of network pressure against time throughout a day illustrating an example of a relationship between a pressure measured at the governor station 12 (herein after referred to as the “governor pressure 30, P_{d}”) and a pressure measured at a low-point 18 of the GDN (hereinafter referred to as the “low-point pressure 32, P₁”). The governor pressure 30 may also be referred to as the “gas supply pressure” herein. As will be appreciated from FIG. 3, the governor pressure 30 is constant in time for a recorded 24 hours. This is because the governor pressure 30 in this example is set manually at the governor station 12. However the low-point pressure 32 is variable in time over the 24 hours. The low-point pressure 32 may drop due to an increased consumer demand, for example. In FIG. 3, the low-point pressure 32 falls in the early morning hours. This is likely as a result of cold temperatures typical of the early morning hours and an increased consumer demand as household heating systems are turned on. An excess pressure 22 representing a difference between a minimum customer pressure 20 and the low-point pressure 32 is shown. The minimum customer pressure 20 may be a minimum statutory pressure or a pressure required to meet consumer service levels, for example. A high excess pressure is undesirable because a higher pressure can increase a likelihood of a higher gas leakage than is necessary to meet the minimum customer pressure 20.

Example embodiments can provide a system and method which can predict a likely demand for gas for a selected GDN and automatically control one or more gas governors of the GDN based on the predicted demand over a predetermined period such as a day, based on a forecast of the weather for the day predicting environmental conditions to reduced excess pressure for the GDN.

Previous attempts have been made to alter pressure profiles in response to consumer demand. For example, GB2252848B discloses a gas supply pressure control apparatus for controlling the pressure of gas in a gas main according to one of a number of pressure profiles stored in electric controller, to provide an appropriate pressure for the time of day, day of the week, season of the year etc.

The required pressure profiles in GB22252848B are graphs of gas pressure in the gas distribution network against time. The pressure profiles are pre-determined from historical data. For example, a pressure profile of pressure against time for a forthcoming winter may be based on the pressure profile recorded from the previous winter. The pressure profile may then be used to control a gas supply pressure. Only one pressure profile can be used by the network at a given point in time and switching of pressure profiles is triggered by pre-determined criteria being met. For example, a summer profile may be triggered based on measurements of ambient temperature variations.

However, there is a need for autonomous gas demand prediction and an increased flexibility in controlling gas supply pressures in response to the prediction in order to minimise financial loss and environmental impact due to gas leakage while ensuring the minimum statutory requirement is met at low-points in the GDN.

Example embodiments of the present technique can control the gas pressure in a selected GDN in accordance with a predicted demand by:
Measuring a gas pressure at one or more low-points in a selected GDN for particular day of the year and for prevailing environmental conditions such air temperature etc;
Calculating a measured gas demand profile from the measured gas pressure at the one or more low points and governor pressures in the selected GDN;
From the measured gas demand profile in the selected GDN, create a parameterised model which can be used to generate a predicted gas demand profile by generating a number of parameters to parameterise the measured gas demand against time, a reduced number of the parameters being used to characterise daily variations in gas demand;
Use a machine learning process to generate selected values for the reduced number of parameters which are required to generate the parameterised model for predicting a demand profile for each day of the year as a function of prevailing environmental conditions, apply the predictions and reiterate to train the machine learning algorithm for environment and predicted demand;
Generate a predicted gas demand profile from the parameterised model of the selected GDN for a particular day of the year, by predicting the at least some of parameters which need to be predicted to represent the predicted demand profile for the measured profile;
Based on predicted environmental conditions, for example, from a weather forecast, set the parameters to corresponding values to generate a predicted demand profile for a day of the year;
For the predicted gas demand profile for the selected GDN, simulate governor pressure settings and resulting low points for the predicted demand profile, score the outcome and reiterate to estimate an optimised or improved pressure settings for the one or more governors of the GDN;
Transmit the governor pressure settings for a predetermined period such as one or more days in advance to match the predicted demand profile;
Measure low point pressures for the selected GDN for the applied governor settings for the one or more days and refine the pressure settings and one or more of the parameters used to generate the predicted gas demand profile. In other words, the measured low-point pressures are used to re-calibrate the parameterised model over time. Therefore, the input parameters of the parameterised model can be modified over time in response to changes in demand for a particular GDN.

It will be appreciated that a “predicted gas demand profile” is a predicted variation in any measure of gas demand with time for a pre-determined forthcoming time period for a GDN. It will be appreciated that a “measured demand profile” is a measured variation in any measure of gas demand with time for a measuring period for a GDN.

The above steps according to an example embodiment will be explained in more detail below.

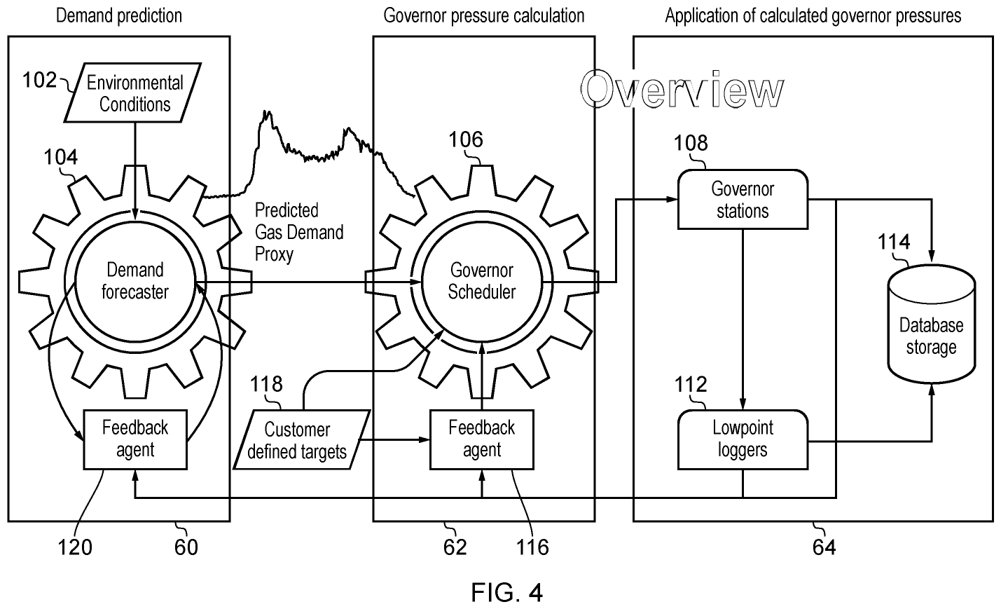

An illustration of an effect of example embodiments is illustrated graphically in FIG. 4. As shown in FIG. 4, example embodiments may be split into three main phases: a demand prediction phase 60, a governor pressure calculation phase 62 and an application phase 64. As mentioned above, the demand prediction phase 60 is concerned with predicting a measure of gas demand in a GDN for a predetermined time period, from a parameterised model based on predicted environmental conditions. The governor pressure calculation phase 62 is concerned with using the parameterised model for predicting gas demand to determine the effect of governor pressures on pressures at low points in the GDN, and estimating an optimum variation in governor pressures with time which minimises excess pressure in the GDN for the predetermined time period. The application phase 64 is concerned with communicating instructions to governor stations to implement the estimated optimum variation in governor pressures with time for the predetermined time period. An “optimum variation in governor pressures with time for the predetermined time period” is a variation in the governor pressures with time over a predetermined period which can meet a pressure condition at one or more pre-determined points in the GDN (such as pressure low points). For example, the optimal variation in governor pressures with time for the predetermined time period may be a variation in governor pressure which can at least reduce gas leakage in the GDN but preferably minimises excess pressure in the GDN for the predetermined time period.

As part of the demand prediction phase, a weather service (such as the Met Office) provides predicted environmental conditions 102 for the pre-determined time period to a demand forecaster 104. The predicted environmental conditions for the predetermined time period may be predicted environmental conditions for an area in which a GDN is located. For example, the predicted environmental conditions may be a weather forecast for a forthcoming day or forthcoming week. In an exemplary embodiment, the predicted environmental conditions are predicted for the forthcoming day. The predicted environmental conditions may include, but are not limited to, one or more of temperature, wind-speed, humidity and the like.

The demand forecaster 104 uses the predicted environmental conditions in a trained machine learning algorithm (as will be explained below) to predict a gas demand proxy (a measure of gas demand) for a GDN for the predetermined time period. A gas demand proxy may be any quantity which is representative of a measure of gas demand over time in the GDN. The demand forecaster 104 provides the predicted gas demand proxy to a governor scheduler 106. As will be explained below, the predicted gas demand proxy can be generated for a particular GDN by measuring low-point pressures for a selected GDN throughout a measuring period in order to model gas demand for the GDN.

As part of the governor pressure calculation phase, the governor scheduler 106 uses the predicted gas demand proxy to obtain a low-point pressure model for the network. The low-point pressure model is configured to use a predicted gas demand proxy to simulate the effect of varying one or more governor pressures in a GDN on one or more low-points in the GDN.

The governor scheduler 106 estimates an optimum variation in governor pressure for the one or more of the governor stations 108 with time for the predetermined time period (such as one or more coming days) which minimises or at least reduces an excess pressure whilst as far as possible ensuring that all of the low-point pressures remain above a minimum pressure value required. In an exemplary embodiment, the governor scheduler 106 estimates the optimum variation in governor pressures with time for the forthcoming day.

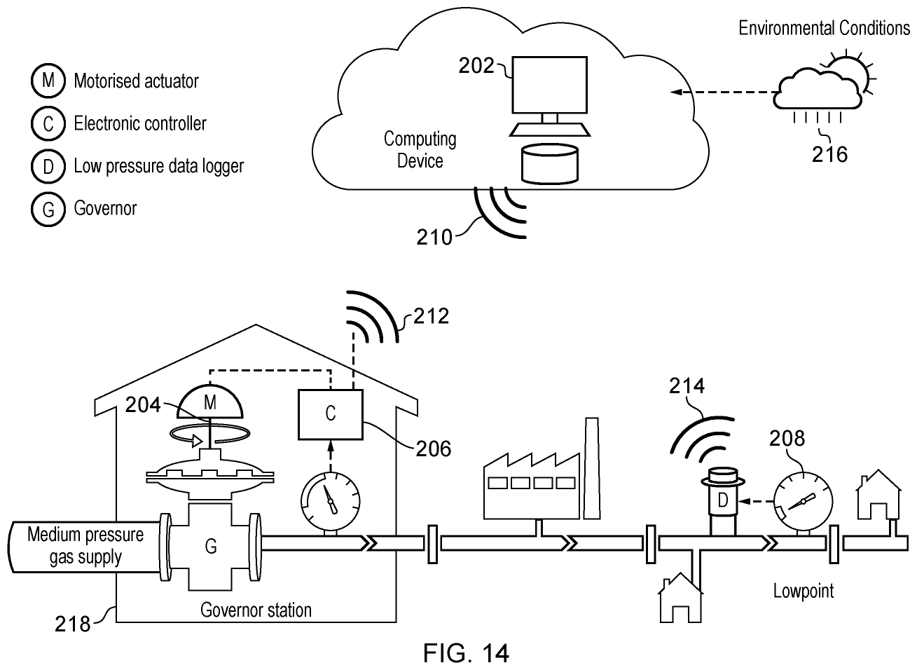

It will be appreciated that the demand forecaster 104 and the governor scheduler 106 are logical entities defined by the functions which they perform and may be implemented in the same or different device. In an exemplary embodiment, which will be explained in detail with reference to FIG. 14 below, the demand forecaster 104 and governor scheduler 106 are both implemented in a remote computing device.

As part of the application phase, the governor scheduler 106 instructs the one or more governor stations 108 in the GDN to set the respective pressures in order to attain the estimated optimum variation in governor pressures with time determined by the governor scheduler 106. The one or more governor stations 108 change a gas pressure of gas input into the one or more governor stations 108 according to the received pressures for the predetermined time period. According to the governor pressure settings for the predetermined time period, gas flows from the one or more governor stations 108. One or more low-point loggers record a gas pressure at one or more pressure low-points in the. One or more of the governor stations 108 and/or one or more of the low-point loggers 112 are configured to store governor pressures and/or low-point pressures in a database 114 respectively.

As shown in FIG. 4, one or more of the governor stations 108 and/or one or more of the low-point loggers 112 may provide feedback to a demand forecasting feedback agent 120 and a governor scheduling feedback agent 116. The demand forecasting feedback agent 120 and the governor scheduling feedback agent 116 may be logical entities which exist in a cloud. The demand forecasting feedback agent 120 may determine an actual measured gas demand based on the feedback received from the one or more governor stations 108 and the one or more low-point loggers 112. The demand forecasting feedback agent 120 may receive the predicted gas demand proxy from the demand forecaster 104. The demand forecasting feedback agent 120 may score how well the machine learning algorithm performed based on how closely the measured demand matches the predicted demand proxy. The demand forecasting agent 120 may determine to refine the parameters in the parameterised model based on the score. The refinement of the parameters may comprise retraining the machine learning algorithm. The demand forecasting agent 120 may provide the refined predicted gas demand proxy to the demand forecaster 104. The governor scheduling feedback agent 116 may determine a measured excess pressure based on the feedback received from the one or more governor stations 108 and the one or more low-point loggers 112. Based on the measured excess pressure, the governor scheduling feedback agent 116 may score how well excess pressure was reduced. The governor scheduling feedback agent 116 may determine to refine the optimised governor pressures based on the score. For example, if the excess pressure was not reduced significantly, the governor scheduling feedback agent 116 may determine to reduce the governor pressures. The governor scheduling feedback agent 116 may transmit the refined optimised governor pressures to the governor scheduler 106. In some embodiments, the governor scheduling feedback agent 116 refines the optimised governor pressures based on the feedback and customer defined targets 118. The consumer defined targets may include one or more of:
A minimum service pressure;
A minimum and/or maximum governor pressure range for one or more governor stations; and
A maximum pressure variance from the pressure at which a governor station is set (alternatively referred to as a “setpoint variance”) for one or more governor stations.

In some embodiments, meeting more consumer defined targets 118 results in a higher score whereas meeting fewer consumer defined targets 116 results in a lower score.

As will be appreciated, an accuracy of the gas demand prediction and the low-point pressure model will be improved if a larger number of learning data sets are used. In this way, the gas demand prediction and low-point pressure model may be continuously revised and improved. The consumer defined targets 118 may include an efficiency indicating an amount of gas leakage prevented by using embodiments of the present disclosure.

### Predicting Demand Using a Gas Demand Proxy (Demand Prediction Phase)

As indicated above, as a first step, a measured gas demand profile is generated from measurements taken from a selected GDN for which example embodiments are to be applied. In exemplary embodiments, a gas demand proxy is used as a gas demand profile. As will be explained below, a gas demand proxy is a measure of gas demand in a GDN. The measured gas demand proxy is parameterised to reduce a number of parameters which are subsequently used to generate a predicted gas demand proxy for the GDN for a predetermined time period. The predicted gas demand proxy for the predetermined time period is predicted based on environmental conditions and used to generate a data set for downloading to the governor stations. Since the data set is reduced based on the parameterised prediction of the gas demand proxy, the governors can receive the data set in advance via a low bandwidth network, such as for example a mobile communications network.

### Measurements for a Selected Network to Produce Demand Proxy Against Time

In accordance with example embodiments, a gas demand proxy is used as a measure of gas demand in a GDN. The gas demand proxy is given by Equation 1 in one example embodiment. It will be appreciated that the gas demand proxy is a measure of gas demand and any other measure of gas demand may be used as will be appreciated by a person skilled in the art.

$$Demand Proxy \approx Governor Pressure - Lowpoint Pressure . \qquad Equation 1$$

The demand proxy in Equation 1 has units of pressure (for example, bar, P_{d} or the like). In equation 1 the governor pressure and low-point pressure are measured values which vary with respect to time for a selected GDN to be controlled. If there are a plurality of governor stations 12 in the GDN 2, the governor pressure may correspond to an average governor pressure obtained by summing the governor pressure of each of the plurality governor stations in the GDN and dividing by the number of governor stations. If there are a plurality of low-point loggers 6 in the GDN 2, the low-point pressure may correspond to an average low-point pressure obtained by summing the low-point pressure of each of the plurality of low-points in the GDN and dividing by the number of low-points. Each quantity in Equation 1 is measured as a function of time.

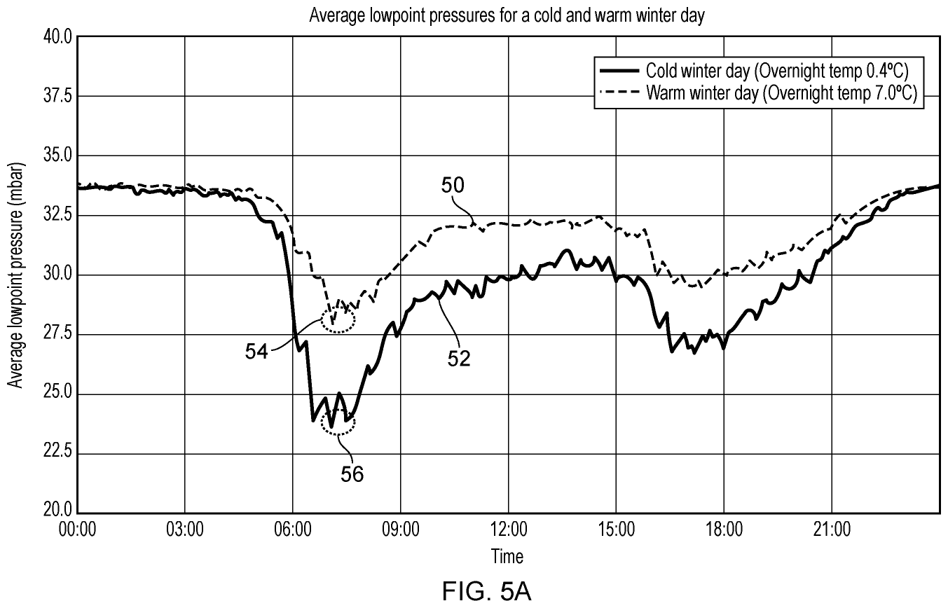

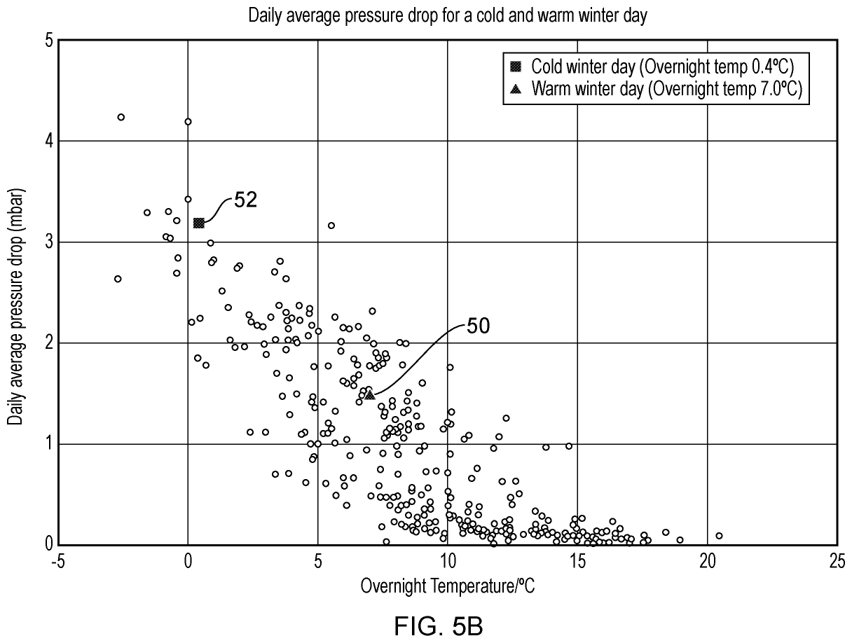

FIGS. 5A and 5B are graphical plots illustrating a relationship between low-point pressure and overnight temperature. FIG. 5A is a graphical plot of an average low-point pressure against time in a 24-hour period for a cold winter day and a warm winter day for a selected GDN and for constant governor pressures. In particular, plot 50 represents a variation in average low-point pressure for a warm winter day (with an overnight temperature of approximately 7.0° C.) over a 24 hour-period and plot 52 represents a variation in average low-point pressure for a cold winter day (with an overnight temperature of approximately 0.4° C.) over two different 24-hour periods for the same GDN. As will be appreciated from FIG. 5A, the plot 52 for the cold winter day and the plot 50 for the warm winter day have approximately the same shape. For example, the lowest average low-point pressure 56 for the plot 52 for the cold winter day occurs at approximately the same time as the lowest average low-point pressure 54 for the plot 50 of the warm winter day (approximately 07:30). The shape of the plots 50, 52 across the 24 hour-period may be determined by daily variations in consumer demand for gas. For example, at around 07:30, the demand for consumer demand may be at its highest for the 24-hour period. Consequently, the average low-point pressure for the GDN is at its lowest point around at around 07:30. The gas demand around 07:30 may be particularly high because a large number of household heating systems are switching on as consumers get up for the day. As will be appreciated from FIG. 5A, the average low-point pressure of the plot 52 for the cold winter day is generally lower throughout the 24 hour period compared with the average low-point pressure of the plot 50 for the warm winter day. In other words, there is a negative correlation between overnight temperature and average low-point pressure for a GDN. The decreasing average low-point pressure as overnight temperature decreases may occur because consumer demand for gas increases as overnight temperature decreases. For example, when overnight temperatures are lower, household heating systems may need to use more gas to reach a desired indoor temperature.

FIG. 5B is a graphical plot illustrating a daily average low-point pressure drop against overnight temperature. The daily average low-point pressure drop is a drop in the low-point pressure from a reference value across a period of 24 hours. As will be appreciated from FIG. 5B, the daily average pressure drop decreases as the overnight temperature increases. For example, as shown in FIG. 5B, the daily average pressure drop for the plot 52 for the cold winter day is higher than the daily average pressure drop for plot 50 for the warm winter day. The increased daily average low-point pressure drop at lower overnight temperatures may be explained by an increased consumer demand for gas at lower overnight temperatures as explained above.

As explained above with reference to FIGS. 5A and 5B, consumer demand may be dependent on overnight temperatures and the time of day. However, it will be appreciated that these are examples and consumer demand may depend on other factors such as wind speed, humidity or the like.

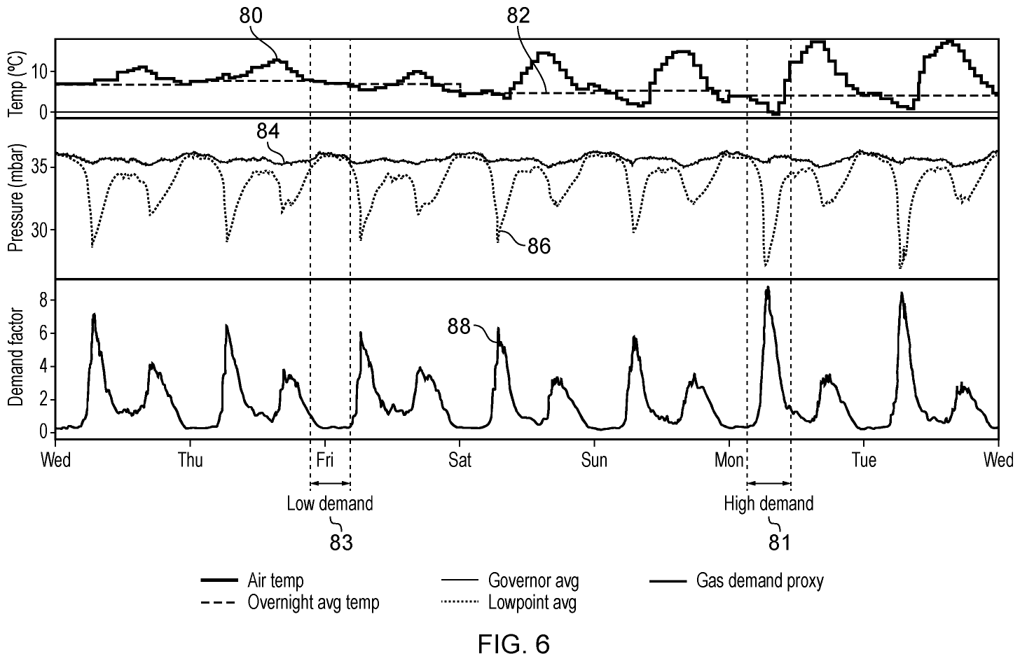

FIG. 6 is a graphical illustration with three plots showing a variation in temperature, network pressure and gas demand in a GDN over a week. Each data point is derived from an average over six minutes. In the example of FIG. 6, there are two hundred and forty data points for each day because there is a six minute average data point for every six minutes. An upper plot shows a variation in temperature with time for the week. As will be appreciated from FIG. 6, overnight average temperature 82 appears substantially constant over the week. However, there is variation in an air temperature 80 over the week. A middle plot shows a variation in network pressure against time over the week. A governor pressure average 84 is substantially constant because, in this example, the governor pressure was manually set at the governor stations. However, the low-point average pressure 86 is variable with time. A lower plot shows a variation in a measured gas demand proxy 88 with time for the week. The measured gas demand proxy 88 is measured using the average low-point pressure 86 and the average governor pressure 84 as indicated in Equation 1. The plot clearly shows variations in gas demand commensurate with environmental conditions. For example, a high demand period 81 is marked on FIG. 6. The high demand period 81 occurs approximately during the early hours of Monday morning. The air temperature 80 at this time is at its lowest point for the week. The average low-point pressure 86 for the same time is also at its lowest point for the week, whereas the measured gas demand proxy 88 is at its highest point for the week. Additionally, a low demand period 83 is marked on FIG. 6. The low demand period 83 occurs approximately during the early hours of Friday morning. The air temperature 80 is higher during low demand period 83 compared with the air temperature 80 during the high demand period 81. Furthermore, the measured gas demand proxy 88 is lower during the low demand period 83 compared with the measured gas demand proxy 88 during the high demand period 81 It will therefore be appreciated that there is a negative correlation between air temperature and gas demand. In other words, gas demand increases as air temperature decreases and vice versa. As indicated above, this may be because lower air temperatures mean more consumers turn on household heating systems or generally stay indoors and use gas appliances. Conversely, gas usage decreases for higher air temperatures because consumers tend to spend more time outdoors and refrain from turning on household heating systems. As will be appreciated, many household gas heating systems operate on thermostats and do not require consumers to manually turn them on in response to cold weather. Thermostats do not usually trigger the heating system overnight and so colder nights mean the building cools down more and heating systems have to work harder to warm it back to the set temperature when the thermostat triggers the heating system to turn on in the morning.

### Parameterising/Modelling Measured Demand Proxy

In order to reduce the number of parameters which must be used to characterize a gas demand proxy (such as the measured gas demand proxy shown in FIG. 6), according to example embodiments, a machine learning algorithm is used to predict the gas demand proxy for a selected GDN. In order to generate a predicted gas demand proxy for the selected GDN for a predetermined time period, the machine learning algorithm may be trained using measurements obtained from the selected GDN at a previous time. In particular, the machine learning algorithm may be trained using a parameterized model of the measured gas demand proxy and corresponding environmental conditions. For example, the machine learning algorithm may be trained using the measured demand proxy 88 and corresponding air temperature 80 in FIG. 6.

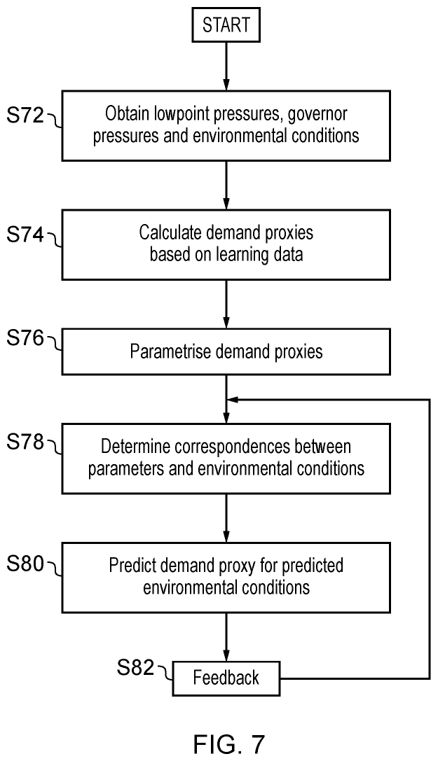

FIG. 7 shows an example method which uses machine learning to generate a parameterised model of the measured gas demand proxy. The parameterised model of the measured gas demand proxy may also be referred to herein as the “parameterised measured gas demand proxy”. The parameterised model can then be used to predict a gas demand proxy for the selected network according to an exemplary embodiment. As a first step, as described above with reference to FIG. 6, measurements of average low-point pressures, average governor pressures and corresponding environmental conditions over a measurement period are taken for a selected network S72. “Corresponding environmental conditions” include any environmental conditions mentioned herein for an area of the GDN during the measurement period.

In step S74, the governor pressures and low-point pressures are used to calculate a measured gas demand proxy for the measurement period using Equation 1. An example of a measured gas demand proxy with corresponding measured environmental conditions is given in FIG. 6. In FIG. 6, the measurement period is one week and the “corresponding measured environmental condition” is the air temperature 80.

In an exemplary embodiment, a large number of gas demand proxies are measured for different measurement periods. For example, if average governor pressures, average low-point pressures and corresponding measured environmental conditions are available for a large number of days, a measured gas demand proxy may be calculated for each day.

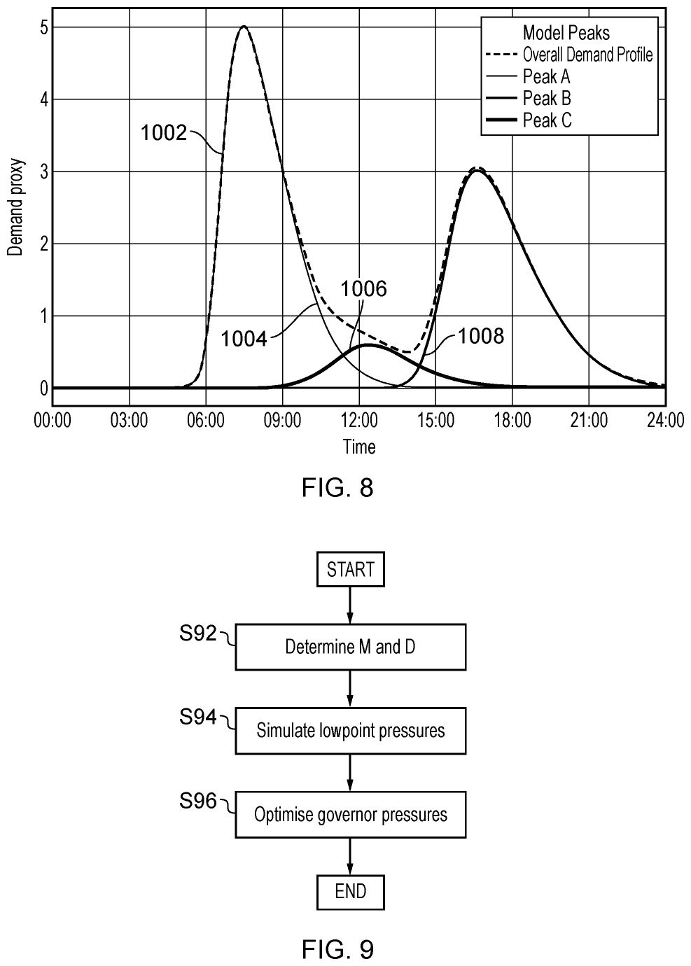

In step S76, the measured gas demand proxies are parameterised/modelled. Parameterising the measured gas demand proxies may lead to a reduction in computer processing power (for example a large amount of computing processing power would be required to predict each of the 240 data points for the measured demand proxy in FIG. 6). Parameterising may include fitting a parameterised curve to a measured demand proxy. A parameterised curve 1002 may be made up of three height-scaled skew normal distributions. For example, as shown in FIG. 8, parameterised curve 1002 is made up of distribution A 1004, distribution B 1006, and distribution C 1008 each of which is a height-scaled skew normal distribution). In some embodiments, each distribution 1004, 1006, 1008 can be represented by four parameters:
a location of a peak of the distribution (for example, an x-axis position of the peak),
a height of the distribution peak (for example, a y-axis position of the peak),
a scale of the distribution peak (alternatively referred to as the “spread” of the distribution), and
a shape of the distribution (alternatively referred to as the “skew” of the distribution).

In some embodiments, the parameter defining the height of distribution C 1006 is determined by the height distribution A 1004 and the height distribution B 1006. In other words, the height of distribution C 1006 is represented by two parameters. For example, the height of distribution C 1006 may be defined as: (n*height of distribution A 1004 height)+ (m*height of distribution B 1008), where n and m are <1. Therefore, in some embodiments, the parameterized curve is represented by 13 parameters. Nine of the parameters correspond to network parameters which are constant for the GDN. For example, the nine parameters may be fixed on a day-to-day basis for a particular GDN and may be different for different GDNs. Four of the parameters are variable for the GDN according to prevailing environmental conditions. In one example, the four variable parameters are the height and location of distribution A 1004 and distribution C 1006. Therefore, by parameterising, only four parameters will be required to be predicted to obtain a predicted gas demand proxy for the GDN for a predetermined time period.

In step S78, a machine learning algorithm uses the parameterised measured gas demand proxies for each day and along with corresponding measured environmental conditions for each day to establish one or more correspondences between the measured environmental conditions and the four variable parameters. In other words, the machine learning algorithm finds relationships between the four variable parameters and measured environmental conditions. For example, if the measured demand proxy 88 in FIG. 6 is parameterised using the 13 parameters, then the machine learning algorithm may determine that there is a negative correlation between air temperature 80 and the measured gas demand proxy. In other words, the machine learning algorithm may determine a relationship between the four parameters which vary for a GDN according to prevailing environmental conditions such that the four parameters result in an increased gas demand prediction if the outside temperature is low. It will be appreciated that the machine learning algorithm establishing correspondences between measured environmental conditions and measured gas demand proxies is an example of “training” the machine learning algorithm. It will be appreciated that any suitable machine learning algorithm can be used. For example, a gradient boosted decision tree (XGBoost) algorithm may be used. In one example, environmental conditions are inputted into a gradient boosted decision tree algorithm which outputs the four variable parameters (for example, the height and location of distribution A 1004 and distribution C 1006). The four variable parameters are then fed into the parameterised model to generate the parameterised curve 1002 as shown in FIG. 8. The gradient boosted decision tree algorithm and parameterised curve 1002 may subsequently be calibrated/trained with weeks/months of data from the GDN.

In step S80, the trained machine learning algorithm uses the established correspondences between the four variable parameters and environmental conditions to predict the value of the four parameters for a predetermined time period based on predicted environmental conditions for the predetermined time period. Predicted environmental conditions may be received from a weather forecast. In other words, the trained machine learning algorithm generates a predicted gas demand proxy on a basis of the predicted environmental conditions. The predicted environmental conditions may include one or more of temperature, wind speed, air pressure, humidity, time of year and the like as will be appreciated by a person skilled in the art.

In step S82, in accordance with example embodiments, feedback is provided to the machine learning algorithm 82. The feedback may include measured governor pressures and measured low-point pressures which can be used to generate a measured gas demand proxy in the GDN for the predetermined time period and corresponding measured environmental conditions. The measured gas demand proxy and the corresponding measured environmental conditions may be used to re-train the machine learning algorithm. In other words, the measured gas demand proxy and the corresponding measured environmental conditions for the predetermined time period may be used in combination with the measured gas demand proxies and corresponding environmental conditions for the measurement period to establish one or more correspondences between the four variable parameters and the environmental conditions. For example, a measured demand proxy may be calculated from Equation 1 using the governor pressures and low-point pressures received in the feedback. The measured demand proxy and measured environmental conditions received from the Met Office 102 for the predetermined time period may be fed into the machine learning algorithm. A parameterised curve may be fitted to the measured gas demand proxy for the predetermined time period with the 13 parameters. The machine algorithm may be retrained to obtain an improved correspondence between the four parameters and the environmental conditions.

As will be appreciated, inputting a larger number of measured gas demand proxies with corresponding measured environmental conditions result in a higher accuracy prediction.

### Predicting Low-Point Pressures Using a Low-Point Pressure Model (Governor Pressure Calculation Phase)

Once the measured gas demand proxy for the selected GDN with respect time over the measurement period has been determined, a predicted demand proxy can be generated based on the variable parameters derived from the weather forecast as set out above in FIG. 7. Next, a low-point pressure model uses the predicted demand proxy to generate an estimate of low-point pressures in the selected GDN with respect to time which result from a given set of governor pressures for a predetermined time period. The low-point pressure model can then be used establish an estimate for optimized governor pressure settings.

Generally, a low-point pressure in a GDN is a function a plurality of factors including but not limited to: a number of governors serving the low-point, a number of consumers in a vicinity of the low-point. Therefore, in some GDN networks, a low-point pressure is dependent on more than one governor. In embodiments with a GDN having two pressure low-points and two governor stations, Equation 2 below may be used as a low-point pressure model to predict a pressure at two different low points in the GDN:

$$[ \begin{matrix}{LP}_{1} \\ {LP}_{2}\end{matrix} ] = [ \begin{matrix}{M}_{a} & {M}_{b} \\ {M}_{c} & {M}_{d}\end{matrix} ] \cdot [ \begin{matrix}{G}_{1} \\ {G}_{2}\end{matrix} ] - d [ \begin{matrix}{D}_{1} \\ {D}_{2}\end{matrix} ] \qquad Equation 2$$

$${LP}_{1} = {G}_{1} {M}_{a} + {G}_{2} {M}_{b} - {dD}_{1}$$

$${LP}_{2} = {G}_{1} {M}_{c} + {G}_{2} {M}_{d} - {dD}_{2} .$$

LP₁=Low-point pressure at a first pressure low-point at a given point in time
LP₂=Low-point pressure at a second pressure low-point at a given point in time
GP₁=Governor Station pressure at a first governor station at a given point in time
GP₂=Governor Station pressure at a second governor station at a given point in time

$$M = [ \begin{matrix}{M}_{a} & {M}_{b} \\ {M}_{c} & {M}_{d}\end{matrix} ] = Governor Coefficient$$

$$D = [ \begin{matrix}{D}_{1} \\ {D}_{2}\end{matrix} ] = Demand Coefficient$$

$$d = gas demand proxy at a given point in time$$

Although Equation 2 relates to a GDN including two governor stations and two pressure low-points, it will be appreciated by one skilled in the art that Equation 2 can be adapted for a GDN with one governor station and one pressure low-point, or adapted for a GDN with more than two governor stations and more than two pressure low-points.

The governor coefficient, M, and the demand coefficient, D, are constants for the selected GDN and satisfy, 0<M, d<1. The governor coefficient represents a responsiveness of low-points to changes in governor pressures. The demand coefficient represents a responsiveness of the low-points to changes in demand. For example, if D₁ is larger than D₂, then the pressure LP₁ is affected to a larger extent by changes in d than the pressure LP₂. This may be for example, because there are a larger number of consumers in a vicinity of LP₁ than in a vicinity of LP₂.

The quantity “d” is a gas demand proxy and is a function of time. When using Equation 2 to determine the coefficients M and D (as will be explained below), “d” is a measured gas demand proxy while LP₁, LP₂, GP₁ and GP₂ are measured low-point pressures and governor pressures. Once M and D are known, Equation 2 is used to estimate low-point pressures which result from a given set of governor pressures. The low-point pressure model can then be used to estimate optimum governor pressures (as will be explained below). In this case, “d” is a predicted gas demand proxy while LP₁, LP₂, are estimated low-point pressures which result from a given set governor pressures GP₁, GP₂.

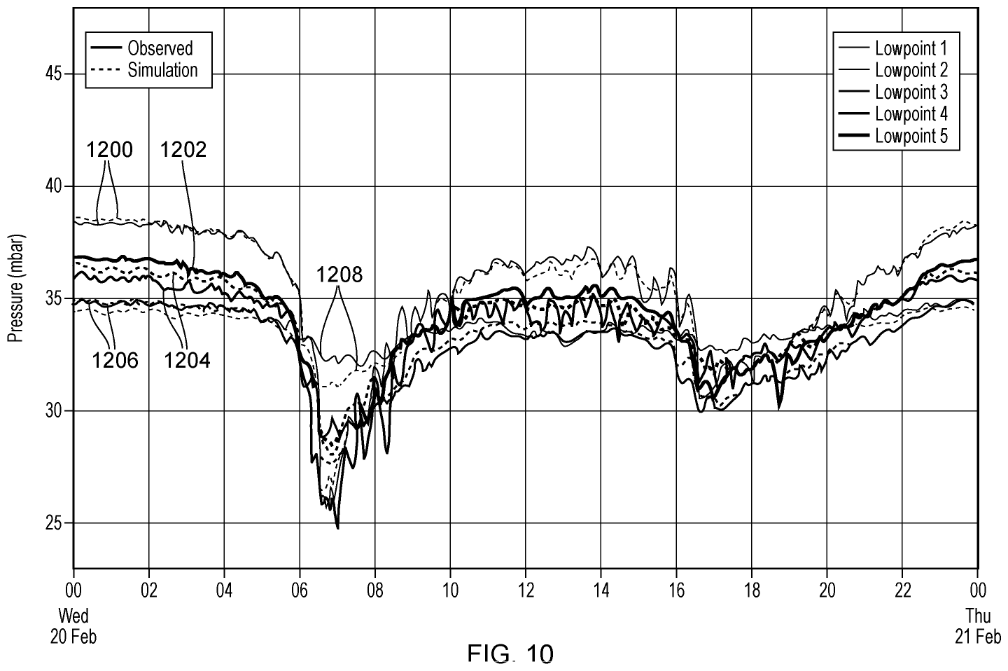

FIG. 9 is a flow diagram illustrating how a low-point pressure model, such as Equation 2, can be used to obtain an estimate of optimal governor pressures. After a start point, the constants M and D of a GDN are determined in step S92. M and D may be determined by numerically solving Equation 2. As indicated above, M and D are constants for the GDN whereas LP₁, LP₂, GP₁, GP₂ and d are functions of time. Therefore a numerical solution for the constants M and D may be found by inputting values for LP₁, LP₂, GP₁, GP₂ and d for a large number of different times, thereby generating a large number of simultaneous equations. The simultaneous equations may be solved by for M and D by any numerical solving technique known to the skilled person. For example, a Sequential Least Squares Programming algorithm or any other constrained numerical optimisation technique may be used. The numerical solving technique for M and D may be executed as part of the machine learning algorithm which is used to establish the correspondences between the environmental conditions and the gas demand proxy. Values of LP₁, LP₂, GP₁, GP₂ and d are obtained by measurement of gas pressure at the first and second low-points and first and second governor stations respectively.

After M and D have been determined for the selected GDN, the determined M and D are input into Equation 2 along with a predicted demand proxy for d (for example the predicted demand proxy generated in step S80 of FIG. 7).

In step S94, with M, D and d inserted into Equation 2, the equation may be used to simulate low-point pressures which result from a given set of governor pressures. In other words, Equation 2 may be used as a low-point pressure model. For example, variations in GP₁ and GP₂ with respect to time may be inserted into Equation 2 along with a variation in a predicted demand proxy with respect time for d. Equation 2 then simulates the variation in LP₁ and LP₂ with respect to time which would result in the GDN.

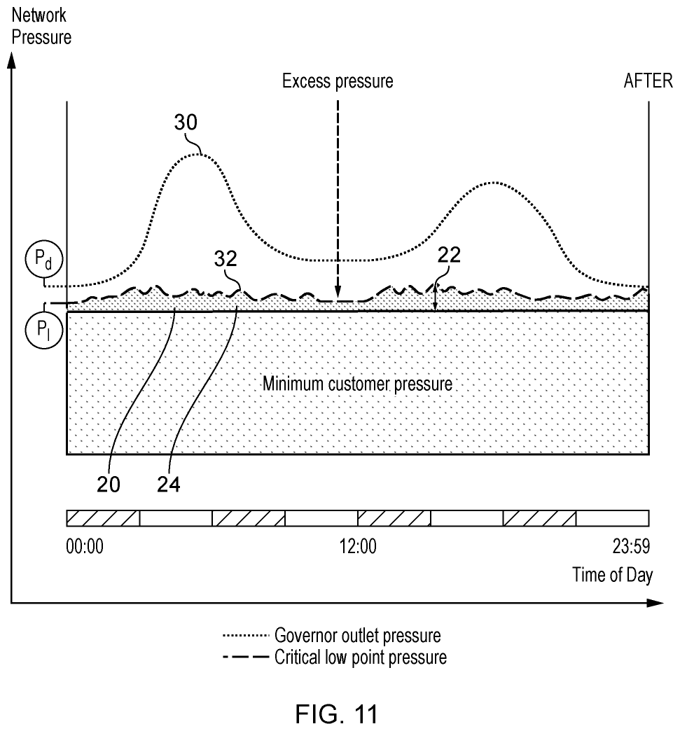

FIG. 10 shows an example of a simulation of the low-point pressure model according to Equation 2 for five low-points 1200, 1202, 1204, 1206, 1208 in a GDN. As will be appreciated from FIG. 10, the simulated low point pressure substantially matches with observed low point pressure for a given set of governor pressures. The simulation may be used to verify that the machine learning algorithm used to determine d is performing adequately and that M and D have been determined to sufficient accuracy.

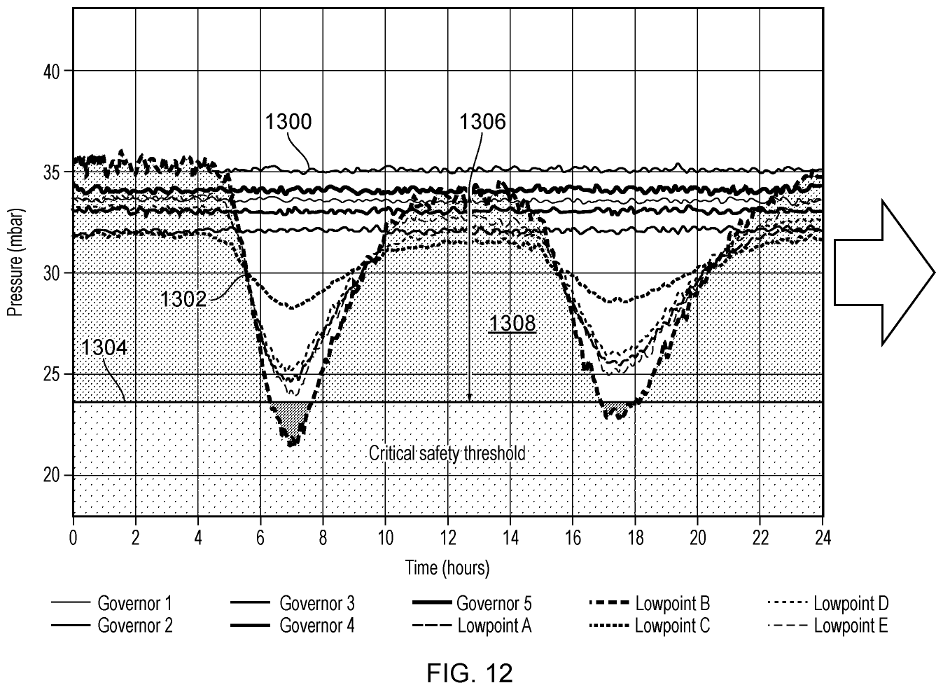

Referring back to FIG. 9, the low-point pressure model is used to simulate the low-point pressures resulting from given sets of governor pressures until the governor pressures are approximately optimised in step S96. As an example of estimating optimum the governor pressures, embodiments can serve to minimise an excess pressure to ensure that a minimum statutory gas pressure requirement is met whilst minimising financial loss and environmental impact due to gas leakage. FIG. 11 is an illustrating of a graphical plot for a GDN with one governor station and one low-point pressure point showing a variation in governor pressure at the governor station which minimises excess pressure at the low-point in accordance with example embodiments.

As will be appreciated from FIG. 11, if the governor pressure 30 is varied as represented by the graphical plot, a resulting low-point pressure 32 at the low-point in the GDN is substantially constant and close to the minimum customer pressure 20. In other words, if the governor pressure is varied as indicated in FIG. 11 then the excess pressure 22 is minimised. Therefore the low-point pressure model (Equation 2) can be used to iteratively input a number of profiles for the governor pressure 30 against time, determine the resulting low-point pressure profiles against time and determine a variation in governor pressure 30 against time which results in a minimum excess pressure 22 against time. As an example, an area 24 between the low-point pressure profile 32 and the minimum customer pressure 20 for a pre-determined period of time may be minimised.

Currently, as shown in FIG. 2, the governor pressure is altered manually at the governor station 12. It would therefore be impractical to continuously vary the governor pressure 30 manually to attain achieve the minimum excess pressure 22.

Embodiments can therefore serve to compensate for drops in low-point pressure 32 resulting from increased demand, by predicting a gas demand proxy in the GDN for the pre-determined time period, simulating the low-point pressures resulting from given sets of governor pressures determining an estimation of optimum governor pressures, and implementing the estimation of the optimum governor pressures at the governor stations. For example, if it is expected that the low point pressure 32 will decrease due to an expected increased consumer demand, the governor pressure 30 should be increased in advance of this situation to ensure the excess pressure is minimised 22.

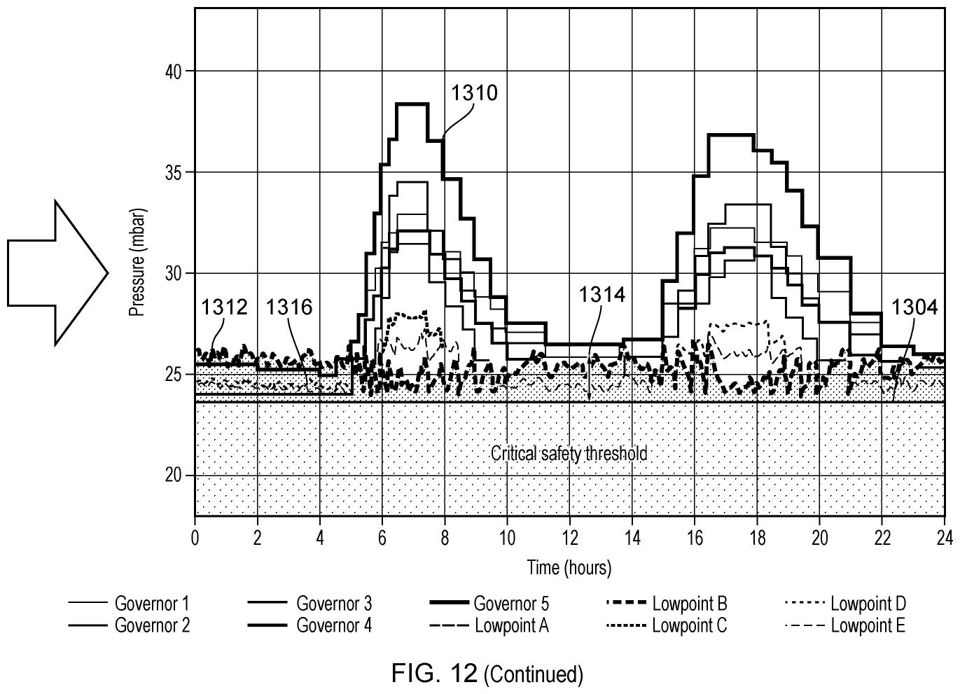

FIG. 12 illustrates a comparison between using five different constant governor pressures 1300 and five different variable governor pressures 1310 in a GDN according to some embodiments. FIG. 12 shows five different low-point pressure curves 1302 resulting from the five different constant governor pressures 1300 and five different low-point pressures curves 1312 resulting from the five variable governor pressures 1310. In both graphs, a critical safety threshold 1304 is shown. Also shown is an excess pressure 1306 for one of the low-point pressures 1302 resulting from the constant governor pressures 1300 as a difference between the one of the low-point pressures 1302 and the safety threshold 1304. Also shown is an excess pressure 1314 for one of the low-point pressures 1312 resulting from the variable governor pressures 1310 as a difference between the one of the low-point pressures 1312 and the safety threshold 1304.

As explained above, a low-point pressure model may be used to predict low-points which result from a given set of governor pressures. Example embodiments can minimise or at least reduce an excess pressure for a selected GDN.

As will be appreciated by a person skilled in the art, whether an estimated governor pressure is “optimal” may depend on a plurality of factors. For example, the optimal governor pressures may be the governor pressures which result in a minimum excess pressure for the GDN. In FIG. 12, a measure of the excess pressure for each of the low-point curves 1302 is given by an area between the respective low-point curve and the minimum threshold 1304. For example, area 1308 represents a measure of excess pressure for one of the low-point pressure curves 1302 resulting from the one of the constant governor pressures 1300 and area 1316 represents a measure of excess pressure for one of the low-point pressure curves 1312 resulting from one of the variable governor pressures 1310. The one or more optimisation techniques may attempt to minimise a sum of the areas between each low-point pressure curve for a GDN and the minimum threshold 1304. The one or more optimisation techniques may be any constrained numerical optimisation algorithm such as a Sequential Least Squares Programming algorithm.

In other examples, the one or more optimisation techniques may attempt to minimise a cost value. In other words, the optimal governor pressures are governor pressures which produce a lowest cost value. A cost value may be consumer dependent. A high cost may be assigned to governor pressures which result in low-point pressures below the minimum threshold. A low cost may be assigned to governor pressures which result in low-point pressures above the minimum threshold but close to it. An indication of an amount of gas leakage saved by adopting embodiments of the present disclosure may be transmitted to the one or more consumers. The indication may include an efficiency as shown in Equation 3 for example.

$$Efficiency 1 - \frac{controlled area under lowpoint pressure}{uncontrolled area under lowpoint pressure} . \qquad Equation 3$$

In example embodiments, the constants M and D may be recalculated. For example, the machine algorithm may be retrained based on feedback including measured governor pressures and low-point pressures and the retrained machine learning algorithm may be used to re-calculate M and D.

### Application Phase

Once an estimation of optimum governor pressures have been determined for a selected GDN, the estimated optimum governor pressures over time are implemented at respective governor stations in the selected GDN for a pre-determined time period. Example embodiments provide a remote means of adjusting pressure at the governor stations in the GDN.

Typically, a delivery pressure, or set point, of governor stations is commonly adjusted by altering the position of a fixed stop within the pilot valve against which a spring, which forms part of the pilot valve, is reacted. The accuracy of fixed stop controlled pilot valves is generally good. However, if any adjustment to the delivery pressure is needed, a visit to the regulator is required to make manual adjustment to the pilot fixed stop position. However, since the estimated optimum governor pressures are variable over the pre-determined time period, it would be impractical in terms of both cost and logistics to alter governor pressures in such a way. Therefore a remote means of governor pressure adjustment is provided.

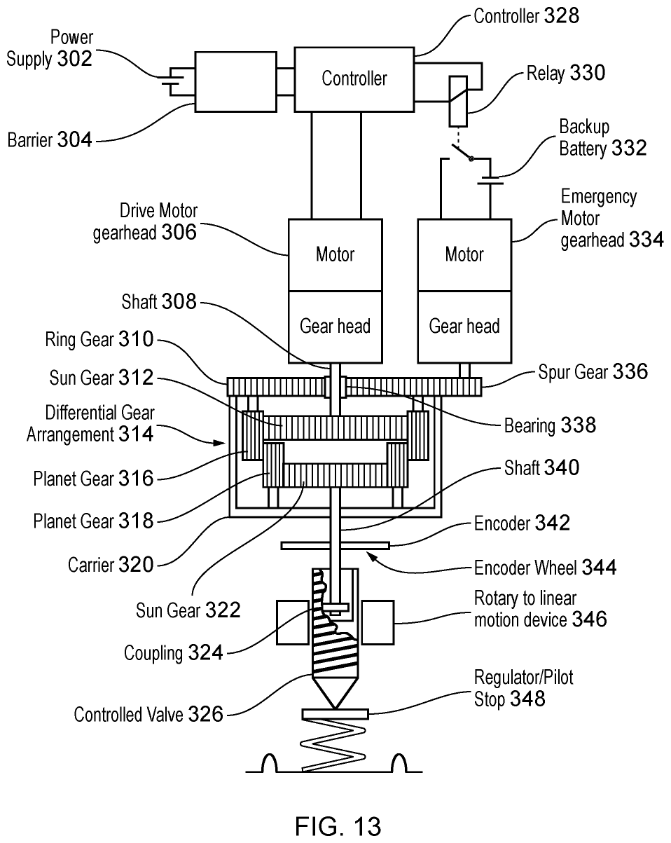

To provide a remote means of adjustment and so that adjustments can be more easily an actuator with a controller configured to receive adjustment instructions is provided in FIG. 13.

In FIG. 13 a motor and gearhead assembly 306, controlled by a controller 328 and external power supply 302, rotates a shaft 308. The shaft passes through but is not connected to a carrier 320. The shaft 308 is connected to a sun gear 312 which forms part of a differential gear system 3.

A differential gear arrangement 314 is formed by sun gear 312, two planet gears 316 and 318 and a further sun gear 322. Planet gears 316 and 318 are mounted on carrier 320 which is arranged to rotate around the motor shaft 308 via a bearing 338 which is mounted between the carrier and shaft. Carrier 320 has a ring gear 310 cut into its circumference and is normally held in a fixed position by engagement with a spur gear 336 connected to the emergency motor gearhead assembly 334.

In a normal operation of the gear system is then for sun gear 312 to rotate planet gear 316. Planet gear 316 then rotates planet gear 318 which in turn rotates sun gear 322. Sun gear 322 is attached to an actuator shaft 340 which connects to a rotary to linear device RLD 346 via a coupling 324. Action of the coupling 324 is to allow linear motion of the rotary to linear device 346 without affecting linear position of the actuator shaft 340. Rotation of the motor 306 is therefore converted to rotation of the rotary to linear device. Rotation of the rotary to linear device 346 converts its rotary motion to a linear motion and this linear motion is communicated to the regulator stop 348 which in turn affects outlet pressure of the controlled valve gas regulator as required. Position of the rotary to linear device 346 is sensed by an encoder 342 monitoring the angular or a linear position of an encoder wheel 344.

The emergency motor gearhead 334 has a power supply independent of the main power supply, formed by an independent backup battery 332 and a normally closed relay 330. Relay 330 is normally held in an open position by action of the controller 328.

It will be appreciated that the apparatus described with respect to FIG. 13 represents one example of pressure control means which can be used to control pressure at a governor station. However, the pressure control means is not limited and the skilled person will appreciated that other pressure control means could be used.

In accordance with example embodiments, the controller 328 may be configured to control fluid pressure based on received information (such as governor station settings). The governor station may also comprise communications circuitry including transceiver circuitry configured to transmit and/or receive signals. The communications circuitry may include controller circuitry configured to control the transceiver circuitry. As will be explained in more detail below with reference to FIG. 14, the communications circuitry may be configured to communicate with a computing device used to generate an estimation of the optimum governor pressures using a mobile communications network. The communications circuitry may receive the estimated optimum governor pressures from the computing device and forward the received optimum governor pressures to the pressure control means. In response, the pressure control means implements the estimated optimum governor pressures over time for the pre-determined period of time.

### Exemplary Fluid Control System

FIG. 14 is a schematic diagram illustrating an exemplary embodiment of fluid control system according to embodiments of the present disclosure. In FIG. 13, a single governor station 218 and a single low-point logger 208 are considered in a GDN although it will be appreciated that one or more governor stations and/or one or more low-point loggers could be used. As will be appreciated from FIG. 13, predicted environmental conditions 216 are provided to a computing device 202. The predicted environmental conditions 216 may be transmitted to the computing device by any wireless communication technique known in the art. As explained above, the predicted environmental conditions 216 may be provided to the computing device 202 by the Met Office. The computing device 202 may perform some or all of the functions of the demand forecaster 104, governor scheduler 106 and/or database 114 as shown in FIG. 4. In other words, the computing device 202 may determine an estimated optimum variation in governor pressure with time for a pre-determined time period to be implemented at the governor station 218. The computing device 202 comprises receiver circuitry configured to receive signals, transmitter circuitry configured to transmit signals and controller circuitry configured to control the receiver and the transmitter. The transmitter circuitry and the receiver circuitry may be alternatively referred to as transceiver circuitry which is configured to transmit and/or receive signals. As shown in FIG. 1, the computing device 202 is configured to communicate with communications circuitry 206 of a governor station 218. The computing device 202 transmits a signal 210 to the communications circuitry 206 including instructions to governor station 218 to implement the estimated optimum variation with time in governor pressure for the pre-determined period of time. For example, the signal 210 may include governor settings to be implemented at the governor station 218 to achieve the estimated optimum variation in governor pressure with time for the pre-determined time period. The signal 210 is received by the communications circuitry 206 in the governor station.

In response to receiving the signal 210, the communications circuitry 206 in the governor station 218 forwards an indication of the signal 210 to pressure control means 204 in the governor station 218. For example, the governor station settings to be implemented may be forwarded to the pressure control means 204. In response, the pressure control means 204 implements the received settings. The pressure control means 204 may broadly correspond to the apparatus shown in FIG. 13.

The pressure control means 204 implements the received settings to alter a pressure of a medium gas pressure supply input to the governor station 218 to the achieve the estimate optimum variation in governor pressure with time for the pre-determined time period.

The governor station 218 may include a measurement means to measure a pressure of gas leaving the governor station. The measurement means provides the pressure of the gas leaving the station to the communications circuitry 206. The communications circuitry 206 in the governor station 218 may then transmit a signal 212 including an indication of the pressure of gas leaving the governor station over time to the computing device 202. The gas leaving the governor station 218 then flows through the remainder of the GDN and a pressure of the gas measured at a low-point by a low-point logger 208. The low point logger may transmit a signal 214 including an indication of the measured low-point pressure to the computing device 202. It will be appreciated that the low-point pressure data may not be available until some time after the low-point has been measured. In this case, processes involving transmission/reception of low-point pressures occur substantially around when the data becomes available. The signals 212, 214 transmitted from the communications circuitry 206 in the governor station 218 and the low-point logger 208 respectively to the computing device 202 contain feedback including measured governor pressures and measured low-point pressures which may be stored by the computing device 202.

It will be appreciated that the words “provide”, “transmit” and “received” used herein refer to communication process. Any wired or wireless communications means could be used for the communications described. For example, communication may be over Wi-Fi, WLAN, Ethernet or the like.

### Fail Safe

In example embodiments, if the transmission of the signal 210 including the governor settings from the computing device 202 to the communications circuitry 206 does not occur by a pre-determined point in time, then a fail safe mode is initiated. In other words, if the governor station 218 does not receive instructions from the computing device 202, the pressure control means 204 operate according to fail safe instructions stored by a data storage means at the governor station 218. The fail safe instructions may comprise pre-determined instructions. For example, if the communications circuitry 206 determines that it has not received instructions from the computing device 202 by the pre-determined point in time, then it may send an indication of this to the pressure control means 204. In response, the pressure control means 204 may control the governor pressure to match a pre-determined seasonal profile.

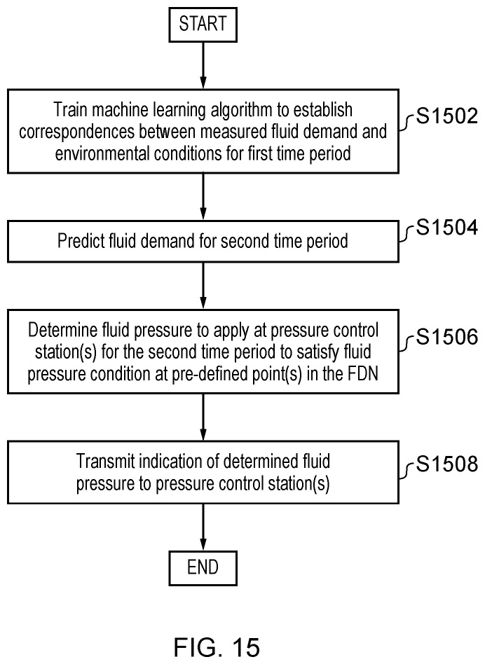

FIG. 15 is a flow diagram illustrating a method performed by a computing device for communicating with one or more pressure-control stations to control fluid pressure in a fluid distribution network, FDN.

In step S1502, the computing device trains a machine learning algorithm to establish one or more correspondences between a measured variation in fluid demand in the FDN for a first time period and measured environmental conditions for the first time period. For example, machine learning can be used to create a predictive model of demand for the FDN using historical pressures and weather data.

In step S1540, the computing device uses the trained machine learning algorithm to predict a variation in fluid demand in the FDN for a second, later time period based on predicted environmental conditions for the FDN for the second time period and the established one or more correspondences between the measured variation in fluid demand in the FDN for the first time period and the measured environmental conditions for the FDN for the first time period.

In step S1506, the computing device determines, based on the predicted variation in fluid demand for the second time period, a variation in fluid pressure to be applied at the one or more pressure control stations for the second time period to satisfy a fluid pressure condition at one or more pre-determined points in the FDN downstream from the one or more pressure control stations. For example, machine learning can be used to create a limited/specialised digital twin to model relationships between the pressures at the pressure control stations, pressures at the pre-determined points in the FDN and demand. Then, future predictions of demand can be used to “interrogate” the digital twin to find a profile of pressure-control station settings which satisfies the fluid pressure condition.

In some embodiments, the fluid pressure condition at the one or more pre-determined points in the FDN downstream from the pressure control stations is a condition to minimise excess pressure in the FDN. For example, the excess pressure may be a difference between a fluid pressure at a pressure low point located at an extremity of the FDN and a minimum permitted fluid pressure. The minimum fluid pressure may be a statutory minimum fluid pressure. In such embodiments, fluid leakage can be reduced while maintaining consumer safety.

In some embodiments, the fluid pressure condition at the one or more pre-determined points in the FDN downstream from the pressure control stations is a condition minimise a difference between a fluid pressure at the one or more pre-determined points in the FDN and a maximum permitted fluid pressure. For example, where the fluid is bio-methane gas, such embodiments can maintain the fluid pressure at the one or more predetermined points under the maximum permitted fluid pressure. As mentioned previously, if the pressure of bio-methane gas exceeds a maximum permitted fluid pressure, then it becomes difficult to feed bio-methane into the FDN. Therefore example embodiments can improve the ease of feeding bio-methane into an FDN without having to burn of excess gas by flaring.

In some embodiments, the fluid pressure condition at the one or more pre-determined points in the FDN downstream from the pressure control stations is a condition that the fluid pressure at the one or more pre-determined points falls within a predefined maximum and minimum fluid pressure. As will be appreciated by one skilled in the art, some countries require fluid pressure at predetermined points in an FDN to be between a maximum and minimum permitted fluid pressure. Therefore example embodiments can accurately control fluid pressure in between maximum and minimum permitted fluid pressure.

The one or more pre-determined points downstream from the one or more pressure control stations may be any point along the FDN which receives fluid from the one or more pressure control stations. For example, the one or more pre-determined points may be pressure low points at extremities of the FDN.

In step S1508, the computing device transmits to the one or more pressure control stations, an indication of the determined variation in fluid pressure to be applied at the one or more pressure-control stations for the second time period to satisfy the fluid pressure condition at the one or more pre-determined points in the FDN. For example, the indication may be an indication of pressure control setting to be used by the one or more pressure control stations for the second timer period. The settings for a pressure control stations may include a variation in set point to be applied by the pressure control station over the second time period.

In some embodiments, feedback can be used to improve the machine learning algorithm. For example, the performance of each machine learning algorithm can be monitored and the models can be retrained with the new data. Then, the retrained models can be tested against historical data. The pressure-control station settings can then be output to accommodate for measured accuracy.

Those skilled in the art would appreciate that the method shown by FIG. 15 may be adapted in accordance with embodiments of the present technique. For example, other intermediate steps may be included in this method, or the steps may be performed in any logical order.

In some embodiments, the steps performed by the computing device may be performed by a pressure control station. For example, a pressure control station may perform steps S1502, S1504 and S1506. The pressure control station may subsequently use pressure control means to adjust a pressure of fluid at the pressure control station in accordance with the determined variation in fluid pressure to be applied at the pressure control station for the second time period to satisfy the fluid pressure condition at the one or more pre-determined points in the FDN. In such embodiments, the pressure control station may comprise pressure-control means for adjusting fluid pressure at the pressure control station, transceiver circuitry configured to transmit and/or receive signals, and controller circuitry configured in combination with the transceiver circuitry. In such embodiments, the computing device may be regarded as comprised in the pressure control station.

The following numbered paragraphs provide further example aspects and features of the present technique:

Paragraph 1. A method performed by a computing device for communicating with one or more pressure-control stations to control fluid pressure in a fluid distribution network, FDN, the method comprising:
training a machine learning algorithm to establish one or more correspondences between a measured variation in fluid demand in the FDN for a first time period and measured environmental conditions for the first time period,
using the trained machine learning algorithm to predict a variation in fluid demand in the FDN for a second, later time period based on predicted environmental conditions for the second time period and the established one or more correspondences between the measured variation in fluid demand in the FDN for the first time period and the measured environmental conditions for the FDN for the first time period,
determining, based on the predicted variation in fluid demand for the second time period, a variation in fluid pressure to be applied at the one or more pressure control stations for the second time period to satisfy a fluid pressure condition at one or more pre-determined points in the FDN downstream from the one or more pressure control stations, and
transmitting, to the one or more pressure control stations, an indication of the determined variation in fluid pressure to be applied at the one or more pressure-control stations for the second time period to satisfy the fluid pressure condition at the one or more pre-determined points in the FDN.

Paragraph 2. A method according to paragraph 1, wherein the indication transmitted by the computing device comprises pressure control settings for the one or more pressure control stations to control fluid pressure in accordance with the determined variation in fluid pressure to be applied at the one or more pressure-control stations for the second time period.

Paragraph 3. A method according to any of paragraphs 1 to 2, wherein the training the machine learning algorithm to establish one or more correspondences between the measured variation in fluid demand for the first time period and the measured environmental conditions for the first time period comprises
modelling the measured variation in the fluid demand for the first time period using a set of parameters, the set of parameters comprising network parameters which are constant for the FDN and environmental parameters which depend on prevailing environmental conditions for the FDN,
training the machine learning algorithm to establish one or more correspondences between a value of each the environmental parameters obtained from the modelling and the measured environmental conditions for the first time period, wherein
the using of the trained machine learning algorithm to predict the variation in fluid demand for the second time period comprises using the trained machine learning algorithm to predict a variation in fluid demand for the second time period based on the predicted environmental conditions and the established one or more correspondences between the value of each the environmental parameters obtained from the modelling and the measured environmental conditions for the first time period for the FDN.

Paragraph 4. A method according to any of paragraphs 1 to 3, wherein the determining the variation in fluid pressure to be applied at the one or more pressure control stations for the second time period comprises
creating, based on the predicted variation in fluid demand for the second time period, a model for simulating fluid pressure at the one or more pre-determined points in the FDN for the second time period for a given set of fluid pressures at the one or more pressure control stations for the second time period, and
using a numerical technique to estimate a variation in fluid pressure to be applied at the one or more pressure-control stations for the second period which would satisfy the pre-determined pressure condition at the one or more pre-determined points in the FDN.

Paragraph 5. A method according to any of paragraphs 1 to 4, wherein the pressure condition is minimising a sum of one or more areas between a curve for each of the simulated fluid pressures at the one or more pre-determined points in the FDN and a minimum permitted fluid pressure in the FDN.

Paragraph 6. A method according to any of paragraphs 1 to 5, comprising
determining the measured variation in fluid demand for the first time period based on a measured variation in fluid pressure at the one or more pressure-control stations for the first time period and a measured variation in fluid pressure at the one or more pre-determined points in the FDN for the first time period.

Paragraph 7. A method according to paragraph 6, wherein the determining the measured variation in fluid demand for the first time period based on the measured variation fluid pressure at the one or more pressure-control stations and the measured variation in fluid pressure at the one or more pre-determined points in the FDN for the first time period comprises
receiving, from the one or more pressure control stations, a measured fluid-pressure at the one or more pressure-control stations for the first time period; and
receiving, from one or more devices located at the one or more pre-determined points in the FDN, a measured fluid pressure at the one or more pre-determined points for the first time period.

Paragraph 8. A method according to any of paragraphs 1 to 7, wherein the training the machine learning algorithm to establish one or more correspondences between the measured variation in fluid demand for the first time period and the measured environmental conditions for the first time period comprises
receiving the measured environmental conditions for the first time period.

Paragraph 9. A method according to any of paragraphs 1 to 8, comprising
receiving the predicted environmental conditions for the FDN for the second time period.

Paragraph 10. A method according to any of paragraphs 1 to 9, wherein the receiving the predicted environmental conditions for the FDN for the second time period comprises
receiving the predicted environmental conditions as a weather forecast for the second period.

Paragraph 11. A method according to any of paragraphs 1 to 10, comprising
receiving, from the one or more pressure-control stations after the second time period, a measured fluid pressure at the one or more pressure-control stations for the second time period,
receiving, after the second time period from one or more devices located at the one or more pre-determined points in the FDN, a measured fluid pressure at the one or more pre-determined points in the FDN for the second time period,
receiving, after the second time period, measured environmental conditions for the second time period,
determining a measured variation in fluid demand for the second time period based on the measured fluid pressure at the one or more pressure-control stations for the second time period and the measured fluid pressure at the one or more pre-determined points in the FDN for the second time period,
retraining the machine learning algorithm to establish one or more correspondences between the measured environmental conditions for the second time period and the measured variation of fluid demand for the second time period.

Paragraph 12. A method according paragraph 11, comprising
storing, the received measured environmental conditions for the second time period, the received fluid pressure at the one or more pressure-control stations for the second time period and the received fluid pressure at the one or more pre-determined for the second time period.

Paragraph 13. A method according to any of paragraphs 1 to 12, wherein the one or more pre-determined points in the FDN are fluid pressure low-points.

Paragraph 14. A method according to any of paragraphs 1 to 13, wherein the second period is a 24 hour period.

Paragraph 15. A method according to any of paragraphs 1 to 14, wherein the fluid is a gas.

Paragraph 16. A computing device for communicating with one or more pressure-control stations to control fluid pressure in a fluid distribution network, FDN, the computing device comprising:
transceiver circuitry configured to transmit and/or receive signals, and
controller circuitry configured in combination with the transceiver circuitry to
train a machine learning algorithm to establish one or more correspondences between a measured variation in fluid demand in the FDN for a first time period and measured environmental conditions for the first time period,
use the trained machine learning algorithm to predict a variation in fluid demand in the FDN for a second, later time period based on predicted environmental conditions for the second time period and the established one or more correspondences between the measured variation in fluid demand in the FDN for the first time period and the measured environmental conditions for the FDN for the first time period,
determine, based on the predicted variation in fluid demand for the second time period, a variation in fluid pressure to be applied at the one or more pressure control stations for the second time period to satisfy a fluid pressure condition at one or more pre-determined points in the FDN downstream from the one or more pressure control stations, and
transmit, to the one or more pressure control stations, an indication of the determined variation in fluid pressure to be applied at the one or more pressure-control stations for the second time period to satisfy the fluid pressure condition at the one or more pre-determined points in the FDN.

Paragraph 17. A computing device according to paragraph 16, wherein the indication transmitted by the computing device comprises pressure control settings for the one or more pressure control stations to control fluid pressure in accordance with the determined variation in fluid pressure to be applied at the one or more pressure-control stations for the second time period.

Paragraph 18. A computing device according to any of paragraphs 16 to 17, wherein the controller circuitry is configured in combination with the transceiver circuitry to
model the measured variation in the fluid demand for the first time period using a set of parameters, the set of parameters comprising network parameters which are constant for the FDN and environmental parameters which depend on prevailing environmental conditions for the FDN,
train the machine learning algorithm to establish one or more correspondences between a value of each the environmental parameters obtained from the modelling and the measured environmental conditions for the first time period,
use the trained machine learning algorithm to predict a variation in fluid demand for the second time period based on the predicted environmental conditions and the established one or more correspondences between the value of each the environmental parameters obtained from the modelling and the measured environmental conditions for the first time period for the FDN.

Paragraph 19. A computing device according to any of paragraphs 16 to 18, wherein the controller circuitry is configured in combination with the transceiver circuitry to
create, based on the predicted variation in fluid demand for the second time period, a model for simulating fluid pressure at the one or more pre-determined points in the FDN for the second time period for a given set of fluid pressures at the one or more pressure control stations for the second time period, and
use a numerical technique to estimate a variation in fluid pressure to be applied at the one or more pressure-control stations for the second period which would satisfy the pre-determined pressure condition at the one or more pre-determined points in the FDN.

Paragraph 20. A computing device according to any of paragraphs 16 to 20, wherein the pressure condition is minimising a sum of one or more areas between a curve for each of the simulated fluid pressures at the one or more pre-determined points in the FDN and a minimum permitted fluid pressure in the FDN.

Paragraph 21. A computing device according to any of paragraphs 16 to 20, wherein the controller circuitry is configured in combination with the transceiver circuitry to
determine the measured variation in fluid demand for the first time period based on a measured variation in fluid pressure at the one or more pressure-control stations for the first time period and a measured variation in fluid pressure at the one or more pre-determined points in the FDN for the first time period.

Paragraph 22. A computing device according to paragraph 21, wherein the controller circuitry is configured in combination with the transceiver circuitry to
receive, from the one or more pressure control stations, a measured fluid-pressure at the one or more pressure-control stations for the first time period, and
receive, from one or more devices located at the one or more pre-determined points in the FDN, a measured fluid pressure at the one or more pre-determined points for the first time period.

Paragraph 23. A computing device according to any of paragraphs 16 to 22, wherein the controller circuitry is configured in combination with the transceiver circuitry to
receive the measured environmental conditions for the first time period.

Paragraph 24. A computing device according to any of paragraphs 16 to 23, wherein the controller circuitry is configured in combination with the transceiver circuitry to
receive the predicted environmental conditions for the FDN for the second time period.

Paragraph 25. A computing device according to any of paragraphs 16 to 24, wherein the controller circuitry is configured in combination with the transceiver circuitry to receiving the predicted environmental conditions as a weather forecast for the second period.

Paragraph 26. A computing device according to any of paragraphs 16 to 25, wherein the controller circuitry is configured in combination with the transceiver circuitry to
receive, from the one or more pressure-control stations after the second time period, a measured fluid pressure at the one or more pressure-control stations for the second time period,
receive, after the second time period from one or more devices located at the one or more pre-determined points in the FDN, a measured fluid pressure at the one or more pre-determined points in the FDN for the second time period,
receive, after the second time period, measured environmental conditions for the second time period,
determine a measured variation in fluid demand for the second time period based on the measured fluid pressure at the one or more pressure-control stations for the second time period and the measured fluid pressure at the one or more pre-determined points in the FDN for the second time period,
retrain the machine learning algorithm to establish one or more correspondences between the measured environmental conditions for the second time period and the measured variation of fluid demand for the second time period.

Paragraph 27. A computing device according paragraph 26, comprising storage means configured to
store the received measured environmental conditions for the second time period, the received fluid pressure at the one or more pressure-control stations for the second time period and the received fluid pressure at the one or more pre-determined for the second time period.

Paragraph 28. A computing device according to any of paragraphs 16 to 27, wherein the one or more pre-determined points in the FDN are fluid pressure low-points.

Paragraph 29. A computing device according to any of paragraphs 16 to 28, wherein the second period is a 24 hour period.

Paragraph 30. A computing device according to any of paragraphs 16 to 29, wherein the fluid is a gas.

Paragraph 31. A method performed by a pressure control station for controlling fluid pressure in a fluid distribution network, FDN, the method comprising:
receiving, from a computing device, an indication of a determined variation in fluid pressure to be applied at the pressure-control station for a future time period to satisfy a fluid pressure condition at one or more pre-determined points in the FDN downstream from the pressure control station; and
adjusting a pressure of fluid at the pressure-control station in accordance with the indication received from the computing device.

Paragraph 32. A method according to paragraph 31, wherein the indication received from the computing device comprises pressure control settings for the pressure control station to control fluid pressure in accordance with the determined variation in fluid pressure to be applied at the pressure-control station for the future time period.

Paragraph 33. A method according to any of paragraphs 31 to 32, wherein the pressure condition is minimising a sum of one or more areas between a curve for each of the simulated fluid pressures at the one or more pre-determined points in the FDN and a minimum permitted fluid pressure in the FDN.

Paragraph 34. A method according to any of paragraphs 31 to 33, comprising
measuring a fluid pressure at the pressure control station for a previous time period before the future time period,
transmitting, to the communications device in advance of the future time period, an indication of the measured fluid-pressure at the pressure-control station for the previous time period.

Paragraph 35. A method according to any of paragraphs 31 to 34, comprising
measuring a fluid pressure at the pressure control station for the future time period,
transmitting, to the communications device, an indication of the measured fluid-pressure at the pressure-control station for the future time period.

Paragraph 36. A method according to any of paragraphs 31 to 35, wherein the future period is a 24 hour period.

Paragraph 37. A method according to any of paragraphs 31 to 36, wherein the fluid is a gas.

Paragraph 38. A pressure control station for controlling fluid pressure in a fluid distribution network, FDN, the pressure control station comprising:
pressure control means for adjusting fluid pressure at the pressure control station,
transceiver circuitry configured to transmit and/or receive signals, and
controller circuitry configured in combination with the transceiver circuitry to
receive, from a computing device, an indication of a determined variation in fluid pressure to be applied at the pressure-control station for a future time period to satisfy a fluid pressure condition at one or more pre-determined points in the FDN downstream from the pressure control station, wherein the pressure control means is configured to
adjust a pressure of fluid at the pressure-control station in accordance with the indication received from the computing device.

Paragraph 39. A pressure control station according to paragraph 38, wherein the indication received from the computing device comprises pressure control settings for the pressure control station to control fluid pressure in accordance with the determined variation in fluid pressure to be applied at the pressure-control station for the future time period.

Paragraph 40. A pressure control station according to any of paragraphs 38 to 39, wherein the pressure condition is minimising a sum of one or more areas between a curve for each of the simulated fluid pressures at the one or more pre-determined points in the FDN and a minimum permitted fluid pressure in the FDN.

Paragraph 41. A pressure control station according to any of paragraphs 38 to 40, comprising measurement means configured to
measure a fluid pressure at the pressure control station for a previous time period before the future time period, wherein the controller circuitry is configured in combination with the transceiver circuitry to
transmit, to the communications device in advance of the future time period, an indication of the measured fluid-pressure at the pressure-control station for the previous time period.

Paragraph 42. A pressure control station according to any of paragraphs 38 to 41, comprising measurement means configured to
measure a fluid pressure at the pressure control station for the future time period, wherein the controller circuitry is configured in combination with the transceiver circuitry to
transmit, to the communications device, an indication of the measured fluid-pressure at the pressure-control station for the future time period.

Paragraph 43. A pressure control station according to any of paragraphs 38 to 42, wherein the future period is a 24 hour period.

Paragraph 44. A pressure control station according to any of paragraphs 38 to 43, wherein the fluid is a gas.

Paragraph 45. A method for controlling fluid pressure in a fluid distribution network, FDN, the method comprising:
training, by a computing device, a machine learning algorithm to establish one or more correspondences between a measured variation in fluid demand in the FDN for a first time period and measured environmental conditions for the first time period,
using, by the computing device, the trained machine learning algorithm to predict a variation in fluid demand in the FDN for a second, later time period based on predicted environmental conditions for the second time period and the established one or more correspondences between the measured variation in fluid demand in the FDN for the first time period and the measured environmental conditions for the FDN for the first time period,
determining, by the computing device based on the predicted variation in fluid demand for the second time period, a variation in fluid pressure to be applied at the one or more pressure control stations for the second time period to satisfy a fluid pressure condition at one or more pre-determined points in the FDN downstream from one or more pressure control stations,
transmitting, by the computing device to the one or more pressure control stations, an indication of the determined variation in fluid pressure to be applied at the one or more pressure-control stations for the second time period to satisfy the fluid pressure condition at the one or more pre-determined points in the FDN,
receiving, by the one or more pressure control stations, the indication of the determined variation in fluid pressure to be applied at the one or more pressure-control stations for the second time period to satisfy the fluid pressure condition at the one or more pre-determined points in the FDN, and
adjusting, by the one or more pressure control stations, a pressure of fluid at the respective pressure control station in accordance with the indication received from the computing device.

Paragraph 46. A system for controlling fluid pressure in a fluid distribution network, FDN, the system comprising
one or more pressure control stations, and
a computing device configured to
train a machine learning algorithm to establish one or more correspondences between a measured variation in fluid demand in the FDN for a first time period and measured environmental conditions for the first time period,
use the trained machine learning algorithm to predict a variation in fluid demand in the FDN for a second, later time period based on predicted environmental conditions for the second time period and the established one or more correspondences between the measured variation in fluid demand in the FDN for the first time period and the measured environmental conditions for the FDN for the first time period,
determine, based on the predicted variation in fluid demand for the second time period, a variation in fluid pressure to be applied at the one or more pressure control stations for the second time period to satisfy a fluid pressure condition at one or more pre-determined points in the FDN downstream from the one or more pressure control stations, and
transmit, to the one or more pressure control stations, an indication of the determined variation in fluid pressure to be applied at the one or more pressure-control stations for the second time period, wherein the one or more pressure control stations are configured to
receive the indication of the determined variation in fluid pressure to be applied at the one or more pressure-control stations for the second time period to satisfy the fluid pressure condition at the one or more pre-determined points in the FDN, and
adjust a pressure of fluid at the respective pressure control station in accordance with the indication received from the computing device.

Paragraph 47. A method performed by a pressure control station for controlling fluid pressure in a fluid distribution network, FDN, the method comprising:
training a machine learning algorithm to establish one or more correspondences between a measured variation in fluid demand in the FDN for a first time period and measured environmental conditions for the first time period,
using the trained machine learning algorithm to predict a variation in fluid demand in the FDN for a second, later time period based on predicted environmental conditions for the second time period and the established one or more correspondences between the measured variation in fluid demand in the FDN for the first time period and the measured environmental conditions for the FDN for the first time period,
determining, based on the predicted variation in fluid demand for the second time period, a variation in fluid pressure to be applied at the pressure control station for the second time period to satisfy a fluid pressure condition at one or more pre-determined points in the FDN downstream from the pressure control station, and
adjusting, a pressure of fluid at the pressure control station in accordance with the determined variation in fluid pressure to be applied at the pressure control station for the second time period to satisfy the fluid pressure condition at the one or more pre-determined points in the FDN.

Paragraph 48. A pressure control station for controlling fluid pressure in a fluid distribution network, FDN, the pressure control station comprising:
pressure-control means for adjusting fluid pressure at the pressure control station,
transceiver circuitry configured to transmit and/or receive signals, and
controller circuitry configured in combination with the transceiver circuitry to
train, a machine learning algorithm to establish one or more correspondences between a measured variation in fluid demand in the FDN for a first time period and measured environmental conditions for the first time period,
use, the trained machine learning algorithm to predict a variation in fluid demand in the FDN for a second, later time period based on predicted environmental conditions for the second time period and the established one or more correspondences between the measured variation in fluid demand in the FDN for the first time period and the measured environmental conditions for the FDN for the first time period,
determine, based on the predicted variation in fluid demand for the second time period, a variation in fluid pressure to be applied at the pressure control station for the second time period to satisfy a fluid pressure condition at one or more pre-determined points in the FDN downstream from the pressure control station, wherein the pressure control means is configured to
adjust a pressure of fluid at the pressure control station in accordance with the determined variation in fluid pressure to be applied at the pressure control station for the second time period to satisfy the fluid pressure condition at the one or more pre-determined points in the FDN.

Paragraph 49. A computer program comprising instructions which, when the program is executed by a computer, cause the computer to carry out the method of any of paragraphs 1 to 15, 31 to 37, 45 and 47.

The following numbered paragraphs provide further example aspects and features of the present technique:

Paragraph 1. A method performed by a computing device for controlling fluid pressure in a fluid distribution network (FDN) above a threshold pressure by communicating with a plurality of pressure-control stations distributed throughout the FDN to independently control a fluid pressure at each of the plurality of pressure control stations, the method comprising:
training a machine learning algorithm to establish one or more correspondences between a measured variation in fluid demand in the FDN for a first time period and measured environmental conditions for the first time period,
using the trained machine learning algorithm to predict a variation in fluid demand in the FDN for a second, later time period based on predicted environmental conditions for the second time period and the established one or more correspondences between the measured variation in fluid demand in the FDN for the first time period and the measured environmental conditions for the FDN for the first time period,
determining, based on the predicted variation in fluid demand for the second time period, a variation in fluid pressure to be applied at the plurality of pressure control stations for the second time period to satisfy a fluid pressure condition at one or more pre-determined points in the FDN downstream from the plurality of pressure control stations, and
transmitting, to the plurality of pressure control stations, an indication of the determined variation in fluid pressure to be applied at the plurality of pressure-control stations for the second time period to satisfy the fluid pressure condition at the one or more pre-determined points in the FDN.

Paragraph 2. A method according to paragraph 1, wherein the indication transmitted by the computing device comprises pressure control settings for the plurality of pressure control stations to control fluid pressure in accordance with the determined variation in fluid pressure to be applied at the plurality of pressure-control stations for the second time period.

Paragraph 3. A method according to any of paragraphs 1 to 2, wherein the training the machine learning algorithm to establish one or more correspondences between the measured variation in fluid demand for the first time period and the measured environmental conditions for the first time period comprises
modelling the measured variation in the fluid demand for the first time period using a set of parameters, the set of parameters comprising network parameters which are constant for the FDN and environmental parameters which depend on prevailing environmental conditions for the FDN,
training the machine learning algorithm to establish one or more correspondences between a value of each the environmental parameters obtained from the modelling and the measured environmental conditions for the first time period, wherein
the using of the trained machine learning algorithm to predict the variation in fluid demand for the second time period comprises using the trained machine learning algorithm to predict a variation in fluid demand for the second time period based on the predicted environmental conditions and the established one or more correspondences between the value of each the environmental parameters obtained from the modelling and the measured environmental conditions for the first time period for the FDN.

Paragraph 4. A method according to any of paragraphs 1 to 3, wherein the determining the variation in fluid pressure to be applied at the plurality of pressure control stations for the second time period comprises
creating, based on the predicted variation in fluid demand for the second time period, a model for simulating fluid pressure at the one or more pre-determined points in the FDN for the second time period for a given set of fluid pressures at the plurality of pressure control stations for the second time period, and
using a numerical technique to estimate a variation in fluid pressure to be applied at the plurality of pressure-control stations for the second period which would satisfy the pre-determined pressure condition at the one or more pre-determined points in the FDN.

Paragraph 5. A method according to any of paragraphs 1 to 4, wherein the pressure condition is minimising a sum of one or more areas between a curve for each of the simulated fluid pressures at the one or more pre-determined points in the FDN and a minimum permitted fluid pressure in the FDN.

Paragraph 6. A method according to any of paragraphs 1 to 5, comprising
determining the measured variation in fluid demand for the first time period based on a measured variation in fluid pressure at the plurality of pressure-control stations for the first time period and a measured variation in fluid pressure at the one or more pre-determined points in the FDN for the first time period.

Paragraph 7. A method according to paragraph 6, wherein the determining the measured variation in fluid demand for the first time period based on the measured variation fluid pressure at the plurality of pressure-control stations and the measured variation in fluid pressure at the one or more pre-determined points in the FDN for the first time period comprises
receiving, from the plurality of pressure control stations, a measured fluid-pressure at the plurality of pressure-control stations for the first time period; and
receiving, from one or more devices located at the one or more pre-determined points in the FDN, a measured fluid pressure at the one or more pre-determined points for the first time period.

Paragraph 8. A method according to any of paragraphs 1 to 7, wherein the training the machine learning algorithm to establish one or more correspondences between the measured variation in fluid demand for the first time period and the measured environmental conditions for the first time period comprises
receiving the measured environmental conditions for the first time period.

Paragraph 9. A method according to any of paragraphs 1 to 8, comprising
receiving the predicted environmental conditions for the FDN for the second time period.

Paragraph 10. A method according to any of paragraphs 1 to 9, wherein the receiving the predicted environmental conditions for the FDN for the second time period comprises
receiving the predicted environmental conditions as a weather forecast for the second period.

Paragraph 11. A method according to any of paragraphs 1 to 10, comprising
receiving, from the plurality of pressure-control stations after the second time period, a measured fluid pressure at the plurality of pressure-control stations for the second time period,
receiving, after the second time period from one or more devices located at the one or more pre-determined points in the FDN, a measured fluid pressure at the one or more pre-determined points in the FDN for the second time period,
receiving, after the second time period, measured environmental conditions for the second time period,
determining a measured variation in fluid demand for the second time period based on the measured fluid pressure at the plurality of pressure-control stations for the second time period and the measured fluid pressure at the one or more pre-determined points in the FDN for the second time period,
retraining the machine learning algorithm to establish one or more correspondences between the measured environmental conditions for the second time period and the measured variation of fluid demand for the second time period.

Paragraph 12. A method according paragraph 11, comprising
storing, the received measured environmental conditions for the second time period, the received fluid pressure at the plurality of pressure-control stations for the second time period and the received fluid pressure at the one or more pre-determined for the second time period.

Paragraph 13. A method according to any of paragraphs 1 to 12, wherein the one or more pre-determined points in the FDN are fluid pressure low-points.

Paragraph 14. A method according to any of paragraphs 1 to 13, wherein the second period is a 24 hour period.

Paragraph 15. A method according to any of paragraphs 1 to 14, wherein the fluid is a gas.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

What is claimed is:

1. A method performed by a computing device for controlling fluid pressure in a fluid distribution network (FDN) above a threshold pressure by communicating with a plurality of pressure-control stations distributed throughout the FDN to independently control a fluid pressure at each of the plurality of pressure control stations, the method comprising:
training a machine learning algorithm to establish one or more correspondences between a measured variation in fluid demand in the FDN for a first time period and measured environmental conditions for the first time period,
using the trained machine learning algorithm to predict a variation in fluid demand in the FDN for a second, later time period based on predicted environmental conditions for the second time period and the established one or more correspondences between the measured variation in fluid demand in the FDN for the first time period and the measured environmental conditions for the FDN for the first time period,
determining, based on the predicted variation in fluid demand for the second time period, a variation in fluid pressure to be applied at the plurality of pressure control stations for the second time period to satisfy a fluid pressure condition at one or more pre-determined points in the FDN downstream from the plurality of pressure control stations, and
transmitting, to the plurality of pressure control stations, an indication of the determined variation in fluid pressure to be applied at the plurality of pressure-control stations for the second time period to satisfy the fluid pressure condition at the one or more pre-determined points in the FDN.

2. A method according to claim 1, wherein the indication transmitted by the computing device comprises pressure control settings for the plurality of pressure control stations to control fluid pressure in accordance with the determined variation in fluid pressure to be applied at the plurality of pressure-control stations for the second time period.

3. A method according to claim 1, wherein the training the machine learning algorithm to establish one or more correspondences between the measured variation in fluid demand for the first time period and the measured environmental conditions for the first time period comprises
modelling the measured variation in the fluid demand for the first time period using a set of parameters, the set of parameters comprising network parameters which are constant for the FDN and environmental parameters which depend on prevailing environmental conditions for the FDN,
training the machine learning algorithm to establish one or more correspondences between a value of each the environmental parameters obtained from the modelling and the measured environmental conditions for the first time period, wherein
the using of the trained machine learning algorithm to predict the variation in fluid demand for the second time period comprises using the trained machine learning algorithm to predict a variation in fluid demand for the second time period based on the predicted environmental conditions and the established one or more correspondences between the value of each the environmental parameters obtained from the modelling and the measured environmental conditions for the first time period for the FDN.

4. A method according to claim 1, wherein the determining the variation in fluid pressure to be applied at the plurality of pressure control stations for the second time period comprises
creating, based on the predicted variation in fluid demand for the second time period, a model for simulating fluid pressure at the one or more pre-determined points in the FDN for the second time period for a given set of fluid pressures at the plurality of pressure control stations for the second time period, and
using a numerical technique to estimate a variation in fluid pressure to be applied at the plurality of pressure-control stations for the second period which would satisfy the pre-determined pressure condition at the one or more pre-determined points in the FDN.

5. A method according to claim 1, wherein the pressure condition is minimising a sum of one or more areas between a curve for each of the simulated fluid pressures at the one or more pre-determined points in the FDN and a minimum permitted fluid pressure in the FDN.

6. A method according to claim 1, comprising determining the measured variation in fluid demand for the first time period based on a measured variation in fluid pressure at the plurality of pressure-control stations for the first time period and a measured variation in fluid pressure at the one or more pre-determined points in the FDN for the first time period.

7. A method according to claim 6, wherein the determining the measured variation in fluid demand for the first time period based on the measured variation fluid pressure at the plurality of pressure-control stations and the measured variation in fluid pressure at the one or more pre-determined points in the FDN for the first time period comprises
receiving, from the plurality of pressure control stations, a measured fluid-pressure at the plurality of pressure-control stations for the first time period; and
receiving, from one or more devices located at the one or more pre-determined points in the FDN, a measured fluid pressure at the one or more pre-determined points for the first time period.

8. A method according to claim 1, wherein the training the machine learning algorithm to establish one or more correspondences between the measured variation in fluid demand for the first time period and the measured environmental conditions for the first time period comprises receiving the measured environmental conditions for the first time period.

9. A method according to claim 1, comprising
receiving the predicted environmental conditions for the FDN for the second time period, wherein the predicted environmental conditions are received as a weather forecast for the second period.

10. A method according to claim 1, comprising
receiving, from the plurality of pressure-control stations after the second time period, a measured fluid pressure at the plurality of pressure-control stations for the second time period,
receiving, after the second time period from one or more devices located at the one or more pre-determined points in the FDN, a measured fluid pressure at the one or more pre-determined points in the FDN for the second time period,
receiving, after the second time period, measured environmental conditions for the second time period,
determining a measured variation in fluid demand for the second time period based on the measured fluid pressure at the plurality of pressure-control stations for the second time period and the measured fluid pressure at the one or more pre-determined points in the FDN for the second time period,
retraining the machine learning algorithm to establish one or more correspondences between the measured environmental conditions for the second time period and the measured variation of fluid demand for the second time period.

11. A method according claim 10, comprising storing, the received measured environmental conditions for the second time period, the received fluid pressure at the plurality of pressure-control stations for the second time period and the received fluid pressure at the one or more pre-determined for the second time period.

12. A method according to claim 1, wherein the one or more pre-determined points in the FDN are fluid pressure low-points.

13. A computing device for controlling fluid pressure in a Fluid Distribution Network (FDN) above a threshold pressure by communicating with a plurality of pressure-control stations distributed throughout the FDN to independently control a fluid pressure at each of the plurality of pressure control stations, the computing device comprising:
transceiver circuitry configured to transmit and/or receive signals, and
controller circuitry configured in combination with the transceiver circuitry to
train a machine learning algorithm to establish one or more correspondences between a measured variation in fluid demand in the FDN for a first time period and measured environmental conditions for the first time period,
use the trained machine learning algorithm to predict a variation in fluid demand in the FDN for a second, later time period based on predicted environmental conditions for the second time period and the established one or more correspondences between the measured variation in fluid demand in the FDN for the first time period and the measured environmental conditions for the FDN for the first time period,
determine, based on the predicted variation in fluid demand for the second time period, a variation in fluid pressure to be applied at the plurality of pressure control stations for the second time period to satisfy a fluid pressure condition at one or more pre-determined points in the FDN downstream from the plurality of pressure control stations, and
transmit, to the plurality of pressure control stations, an indication of the determined variation in fluid pressure to be applied at the plurality of pressure-control stations for the second time period to satisfy the fluid pressure condition at the one or more pre-determined points in the FDN.

14. A computing device according to claim 13, wherein the indication transmitted by the computing device comprises pressure control settings for the plurality of pressure control stations to control fluid pressure in accordance with the determined variation in fluid pressure to be applied at the plurality of pressure-control stations for the second time period.

15. A computing device according to claim 13, wherein the controller circuitry is configured in combination with the transceiver circuitry to
model the measured variation in the fluid demand for the first time period using a set of parameters, the set of parameters comprising network parameters which are constant for the FDN and environmental parameters which depend on prevailing environmental conditions for the FDN,
train the machine learning algorithm to establish one or more correspondences between a value of each the environmental parameters obtained from the modelling and the measured environmental conditions for the first time period,
use the trained machine learning algorithm to predict a variation in fluid demand for the second time period based on the predicted environmental conditions and the established one or more correspondences between the value of each the environmental parameters obtained from the modelling and the measured environmental conditions for the first time period for the FDN.

16. A pressure control station for controlling fluid pressure in a fluid distribution network, FDN, the pressure control station comprising:
pressure control means for adjusting fluid pressure at the pressure control station,
transceiver circuitry configured to transmit and/or receive signals, and
controller circuitry configured in combination with the transceiver circuitry to
receive, from a computing device, an indication of a determined variation in fluid pressure to be applied at the pressure-control station for a future time period to satisfy a fluid pressure condition at one or more pre-determined points in the FDN downstream from the pressure control station, wherein the pressure control means is configured to adjust a pressure of fluid at the pressure-control station in accordance with the indication received from the computing device.

17. A pressure control station according to claim 16 wherein the controller circuitry is further configured in combination with the transceiver circuitry to
train, a machine learning algorithm to establish one or more correspondences between a measured variation in fluid demand in the FDN for a first time period and measured environmental conditions for the first time period,
use, the trained machine learning algorithm to predict a variation in fluid demand in the FDN for a second, later time period based on predicted environmental conditions for the second time period and the established one or more correspondences between the measured variation in fluid demand in the FDN for the first time period and the measured environmental conditions for the FDN for the first time period,
determine, based on the predicted variation in fluid demand for the second time period, a variation in fluid pressure to be applied at the pressure control station for the second time period to satisfy a fluid pressure condition at one or more pre-determined points in the FDN downstream from the pressure control station, wherein the pressure control means is configured to
adjust a pressure of fluid at the pressure control station in accordance with the determined variation in fluid pressure to be applied at the pressure control station for the second time period to satisfy the fluid pressure condition at the one or more pre-determined points in the FDN.
